(19) United States
(12) Patent Application Publication
(10) Pub. No.: US 2025/0363286 A1
(43) Pub. Date: Nov. 27, 2025

(54) INTEGRATED CIRCUIT DESIGN SYSTEM, METHOD AND COMPUTER PROGRAM PRODUCT

(71) Applicant: TAIWAN SEMICONDUCTOR MANUFACTURING COMPANY, LTD., Hsinchu (TW)

(72) Inventors: Kai Fai CHANG, Hsinchu (TW); Johnny Chiahao LI, Hsinchu (TW); Wei-Min TSENG, Hsinchu (TW); Chun-Hsien WEN, Hsinchu (TW); Jerry Chang Jui KAO, Hsinchu (TW); Chih-Wei CHANG, Hsinchu (TW)

(21) Appl. No.: 19/288,855

(22) Filed: Aug. 1, 2025

Related U.S. Application Data
(63) Continuation of application No. 18/498,338, filed on Oct. 31, 2023.
(60) Provisional application No. 63/510,799, filed on Jun. 28, 2023.

(51) Int. Cl. G06F 30/398; G06F 30/392; G06F 30/3953; G06F 117/12; G06F 119/02; G06F 119/08; H01L 23/528

(52) U.S. Cl. CPC G06F 30/398; G06F 30/392; G06F 30/3953; H01L 23/5283; H01L 23/5286; G06F 2117/12; G06F 2119/02; G06F 2119/08

(57) ABSTRACT

A system includes a processor for performing a thermal analysis for an IC layout, which includes a redistribution structure having a plurality of conductive layers stacked in a thickness direction. Based on a thickness of each conductive layer of the plurality of conductive layers along the thickness direction and a width of conductive patterns in the conductive layer, the processor divides the plurality of conductive layers into a plurality of different groups each including one or more conductive layers. The processor applies a plurality of different partitioning rules correspondingly to the plurality of different groups, to partition the plurality of conductive layers into a plurality of meshes. The processor performs a thermal simulation for the IC layout based on the plurality of meshes, and, based on the thermal simulation result, modifies the IC layout or proceeds with manufacturing one or more IC devices corresponding to the IC layout.

### RELATED APPLICATION(S)

This application is a continuation application of U.S. patent application Ser. No. 18/498,338, filed Oct. 31, 2023, which claims the benefit of U.S. Provisional Application No. 63/510,799, filed Jun. 28, 2023. The above-referenced applications are herein incorporated by reference in their entireties.

### BACKGROUND

An integrated circuit (IC) typically includes a number of semiconductor devices represented in an IC layout. The IC layout is generated from an IC schematic, such as an electrical diagram of the IC. At various steps during the IC design process, from the IC schematic to the IC layout for actual manufacture of the IC, various checking and testing are performed to make sure that IC devices corresponding to the IC layout can be made and will function as designed.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a functional flow chart of at least a portion of an IC design flow, in accordance with some embodiments.

FIG. 2A is a schematic view of a layout of an example cell, in accordance with some embodiments. FIG. 2B is a schematic cross-sectional view of a portion of an IC device, in accordance with some embodiments.

FIG. 3A is a flowchart of a thermal analysis, in accordance with some embodiments. FIG. 3B is a schematic perspective view of a portion of an IC device modeled in a thermal analysis, in accordance with some embodiments. FIG. 3C is a schematic perspective view and FIG. 3D is a schematic plan view of a portion of an IC device with various boundary conditions assigned in a thermal analysis, in accordance with some embodiments.

FIG. 4 is a flowchart of a thermal analysis, in accordance with some embodiments.

FIG. 5A is a flowchart of a thermal analysis, and FIGS. 5B-5C are schematic perspective views of portions of IC devices modeled in a thermal analysis, in accordance with some embodiments.

FIG. 6A is a flowchart of a thermal analysis, and FIG. 6B is a schematic perspective view of a portion of an IC device modeled in a thermal analysis, in accordance with some embodiments.

FIG. 7A is a flowchart of a thermal analysis, and FIG. 7B is a table corresponding to modeling rules for a thermal analysis, in accordance with some embodiments.

FIG. 8A is a flowchart of a thermal analysis, and FIG. 8B is a schematic perspective view of a portion of an IC device modeled in a thermal analysis, in accordance with some embodiments.

FIG. 9 is a flowchart of a method, in accordance with some embodiments.

FIG. 10 is a block diagram of an electronic design automation (EDA) system in accordance with some embodiments.

FIG. 11 is a block diagram of an IC device manufacturing system, and an IC manufacturing flow associated therewith, in accordance with some embodiments.

### DETAILED DESCRIPTION

The following disclosure provides different embodiments, or examples, for implementing features of the provided subject matter. Specific examples of components, materials, values, steps, arrangements, or the like, are described below to simplify the present disclosure. These are, of course, merely examples and are not limiting. Other components, materials, values, steps, arrangements, or the like, are contemplated. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed. Source/drain(s) may refer to a source or a drain, individually or collectively dependent upon the context.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

In an IC design process, one or more pre-manufacturing verifications are directed to heat generation and/or heat dissipation to regulate device reliability. A reason is that when an IC device experiences excessive temperatures and/or uneven temperature/heat distributions during operation, the IC device's reliability potentially suffers and a risk of device failure increases. In some embodiments, a thermal analysis is performed as a heat-related pre-manufacturing verification. In at least one embodiment, the thermal analysis comprises a thermal simulation for an IC layout which comprises circuit elements, and a redistribution structure configured to connect the circuit elements with each other and/or with external circuitry via off-chip interconnects of the redistribution structure. The thermal simulation is based on models of a plurality of conductive layers in the redistribution structure, and/or using boundary conditions assigned to the off-chip interconnects.

In some embodiments, models of different conductive layers are generated using different modeling rules, based on at least one property of the conductive layers and/or one or more conditions or criteria. As a result, it is possible in one or more embodiments to customize a resolution at which each of the conductive layers is modeled. For example, a thicker and/or wider conductive layer is modeled at a higher resolution, in a finer mesh, and/or with larger mesh units, whereas a thinner and/or narrower conductive layer is modeled at a lower resolution, in a coarser mesh, and/or with smaller mesh units. With such modeling approaches, a balance between accuracy and processing time (e.g., runtime) is achievable in one or more embodiments. The thermal analysis in accordance with some embodiments provides an improvement over a first, other approach which uses a density based simulation which is capable of a full-chip thermal simulation with short runtime, but low accuracy in various situations. The thermal analysis in accordance with some embodiments also provides an improvement over a second, other approach which uses fine meshes for all conductive layers to achieve high accuracy, but with significantly increased runtime in various situations.

In some embodiments, boundary conditions assigned to off-chip interconnects of a redistribution structure in a thermal analysis are not the same. Instead, different boundary conditions are assigned to different off-chip interconnects based on connectivity of the off-chip interconnects with the external circuitry. For example, an off-chip interconnect configured to be coupled to a power rail of the external circuitry has a high heat dissipation capability (because a power rail is often a wide conductive line or a conductive plane), and is assigned with a boundary condition corresponding to such high heat dissipation capability. In contrast, another off-chip interconnect configured to be coupled to a signal line of the external circuitry has a low heat dissipation capability (because a signal line is often narrower than a power rail), and is assigned with another boundary condition corresponding to such low heat dissipation capability. As a result, it is possible in one or more embodiments to increase accuracy of the thermal simulation to reflect actual operational conditions under which IC devices to be manufactured will operate. This is an improvement over other approaches which use the same boundary condition for all off-chip interconnects regardless of their connectivity with the external circuitry. Other effects and/or advantages are within the scopes of various embodiments, as described herein.

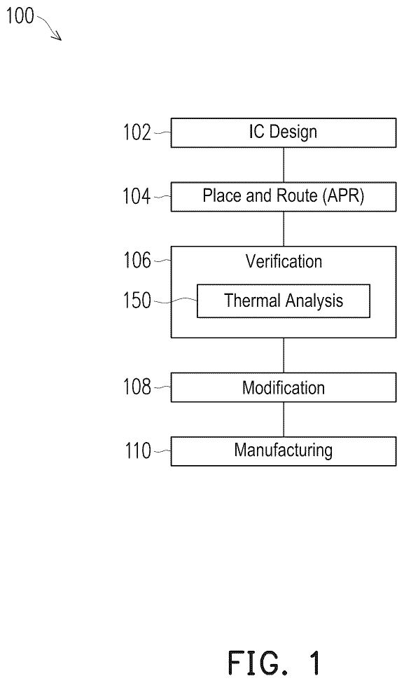

FIG. 1 is a functional flow chart of at least a portion of an IC design flow 100 in accordance with some embodiments. The IC design flow 100 utilizes one or more electronic design automation (EDA) tools (or EDA systems) for generating, optimizing and/or verifying a design of an IC device before manufacturing. The EDA tools, in some embodiments, are one or more sets of executable instructions for execution by one or more processors or controllers or programmed computers, as described herein, to perform the indicated functionality. In at least one embodiment, the IC design flow 100 is performed by a design house of an IC manufacturing system as discussed herein.

At IC design generation operation 102, a design of an IC device is provided by a circuit designer. In some embodiments, the design of the IC device comprises an IC schematic, i.e., an electrical diagram, of the IC device. In some embodiments, the schematic is generated or provided in the form of a schematic netlist, such as a Simulation Program with Integrated Circuit Emphasis (SPICE) netlist. Other data formats, e.g., Verilog, for describing the design are usable in some embodiments. In some embodiments, a pre-layout simulation (not shown) is performed on the design to determine whether the design meets a predetermined specification. When the design does not meet the predetermined specification, the IC device is redesigned. In at least one embodiment, a pre-layout simulation is omitted.

At cell placement and routing (or Place and Route) operation 104, a layout (also referred to as “IC layout”) of the IC device is generated based on the IC schematic. The cell placement and routing operation 104 is referred to as Automatic Placement and Routing (APR) in at least one embodiment. The IC layout comprises physical positions of various circuit elements of the IC device as well as physical positions of various nets interconnecting the circuit elements. For example, the IC layout is generated in the form of a Graphic Design System (GDS) or GDSII file. Other data formats, e.g., Design Exchange Format (DEF), for describing the design of the IC device are within the scope of various embodiments. In at least one embodiment, the IC layout is generated by an EDA tool, such as an APR tool. The APR tool receives the design of the IC device in the form of a netlist as described herein. The APR tool performs floor planning to identify circuit elements, which are to be electrically connected to each other and which are to be placed in close proximity to each other, for reducing the area of the IC device and/or reducing time delays of signals travelling over the interconnections or nets connecting the electrically connected circuit elements. In some embodiments, the APR tool performs partitioning to divide the design of the IC device into a plurality of blocks or groups, such as clock and logic groups. Example operations by the APR tool include, but are not limited to, a cell placement operation and a routing operation.

In a cell placement operation, the APR tool performs cell placement. Cells configured to provide pre-defined functions and having pre-designed layouts are stored in one or more cell libraries, for example, in Library Exchange Format (LEF). LEF is a specification that includes design rules and information about cells in a library. In at least one embodiment, LEF is used with DEF to represent a physical layout of an IC being designed. The APR tool accesses various cells from one or more cell libraries, and places the cells in an abutting manner to generate an IC layout corresponding to the IC schematic. Each cell includes one or more circuit elements and/or one or more nets. A circuit element (also referred to as “circuit device”) is an active element (also referred to as “active device”) or a passive element (also referred to as “passive device”). Examples of active elements include, but are not limited to, transistors and diodes. Examples of transistors include, but are not limited to, metal oxide semiconductor field effect transistors (MOSFET), complementary metal oxide semiconductor (CMOS) transistors, bipolar junction transistors (BJTs), high voltage transistors, high frequency transistors, p-channel and/or n-channel field effect transistors (PFETs/NFETs), FinFETs, planar MOS transistors with raised source/drains, nanosheet FETs, nanowire FETs, or the like. Examples of passive elements include, but are not limited to, capacitors, inductors, fuses, and resistors. Examples of nets include, but are not limited to, vias, conductive pads, conductive traces, and conductive redistribution layers, or the like. Examples of cells include, but are not limited to, AND, OR, NAND, NOR, XOR, INV, OR-AND-Invert (OAI), MUX, Flip-flop, BUFF, Latch, delay, clock, memory such as static random-access memory (SRAM), de-coupling capacitor, analog amplifier, logic driver, digital driver, or the like.

In a routing operation, the APR tool performs routing to route various nets interconnecting the placed circuit elements. The routing is performed to ensure that the routed interconnections or nets satisfy a set of constraints. For example, the routing operation includes global routing, track assignment and detailed routing. During the global routing, routing resources used for interconnections or nets are allocated. For example, the routing area is divided into a number of sub-areas, pins (or terminals) of the placed circuit elements are mapped to the sub-areas, and nets are constructed as sets of sub-areas in which interconnections are physically routable. During the track assignment, the APR tool assigns interconnections or nets to corresponding conductive layers of the IC layout. During the detailed routing, the APR tool routes interconnections or nets in the assigned conductive layers and within the global routing resources. For example, detailed, physical interconnections are generated within the corresponding sets of sub-areas defined at the global routing and in the conductive layers defined at the track assignment. After the routing operation, the APR tool outputs the IC layout including the placed circuit elements and routed nets. The described APR tool is an example. Other arrangements are within the scope of various embodiments. For example, in one or more embodiments, one or more of the described operations are omitted or one or more additional operations are added before, during, or after the described operations.

At verification operation 106, one or more verifications are performed after the cell placement and routing operation 104. Example verifications include, but are not limited to, a layout-versus-schematic (LVS) check, a design rule check (DRC), a timing analysis, or the like. In the example configuration in FIG. 1, the verification operation 106 further comprises a thermal analysis 150. Other verification processes are usable in various embodiments.

An LVS check is performed, e.g., by an EDA tool, to ensure that the generated IC layout corresponds to the design of the IC device. Specifically, an LVS checking tool, i.e., an EDA tool, recognizes electrical components as well as connections therebetween from the patterns of the generated IC layout. The LVS checking tool then generates a layout netlist representing the recognized electrical components and connections. The layout netlist generated from the IC layout is compared, by the LVS checking tool, with the schematic netlist of the design of the IC device. If the two netlists do not match within a matching tolerance, a modification is made to the IC layout at modification operation 108. In some embodiments, the process is returned to the cell placement and routing operation 104 to directly make a modification to the IC layout. In at least one embodiment, the process is returned to the IC design generation operation 102 to change the IC device design which, in turn, will result in a modification being indirectly made to the IC layout. If the two netlists match within the matching tolerance, the LVS check is passed, and the IC layout is subject to a subsequent verification or is output to manufacturing operation 110 for manufacturing one or more IC devices corresponding to the IC layout.

A DRC is performed, e.g., by an EDA tool, to ensure that the IC layout satisfies certain manufacturing design rules, i.e., to ensure manufacturability of the IC device. If one or more design rules is/are violated, a modification is made to the IC layout either directly, or indirectly by changing the design of the IC device, at modification operation 108, as described herein. Examples of design rules include, but are not limited to, a width rule which specifies a minimum width of a pattern in the IC layout, a spacing rule which specifies a minimum spacing between adjacent patterns in the IC layout, an area rule which specifies a minimum area of a pattern in the IC layout, or the like. If all design rules are satisfied, the DRC is passed, and the IC layout is subject to a subsequent verification or is output to manufacturing operation 110.

A timing analysis includes resistance and capacitance (RC) extraction, e.g., by an EDA tool, to determine parasitic parameters, e.g., parasitic resistance and parasitic capacitance, of components in the IC layout. The EDA tool then estimates delays in a plurality of paths in the IC layout, using input data including, but not limited to, the IC layout, the parasitic parameters extracted by the RC extraction, cell delays obtained from one or more cell libraries having cells included in the IC layout, or the like. The timing analysis is performed with, or without, a simulation of operation of an IC device corresponding to the IC layout. In at least one embodiment, when the delays estimated in the timing analysis for one or more paths fail to meet corresponding timing requirements, a modification is made to the IC layout, either directly or indirectly, at modification operation 108, as described herein. If all timing requirements are satisfied, the IC layout is subject to a subsequent verification or is output to manufacturing operation 110.

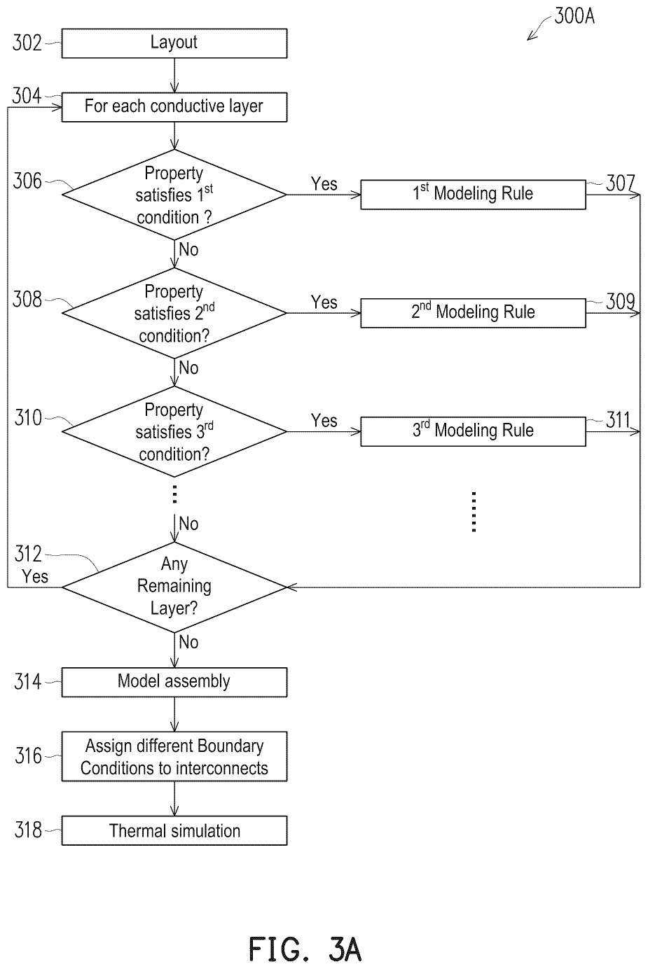

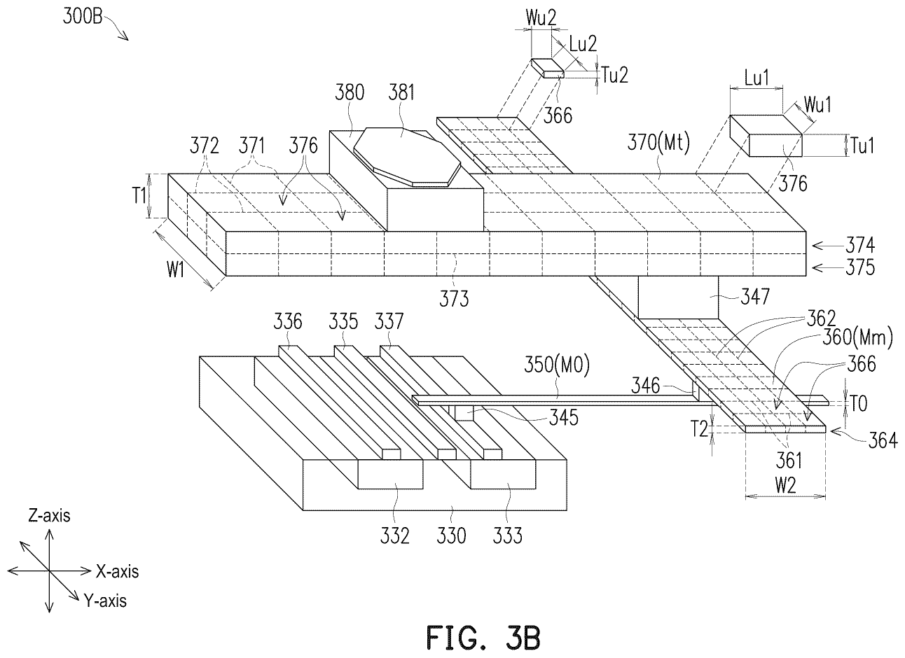

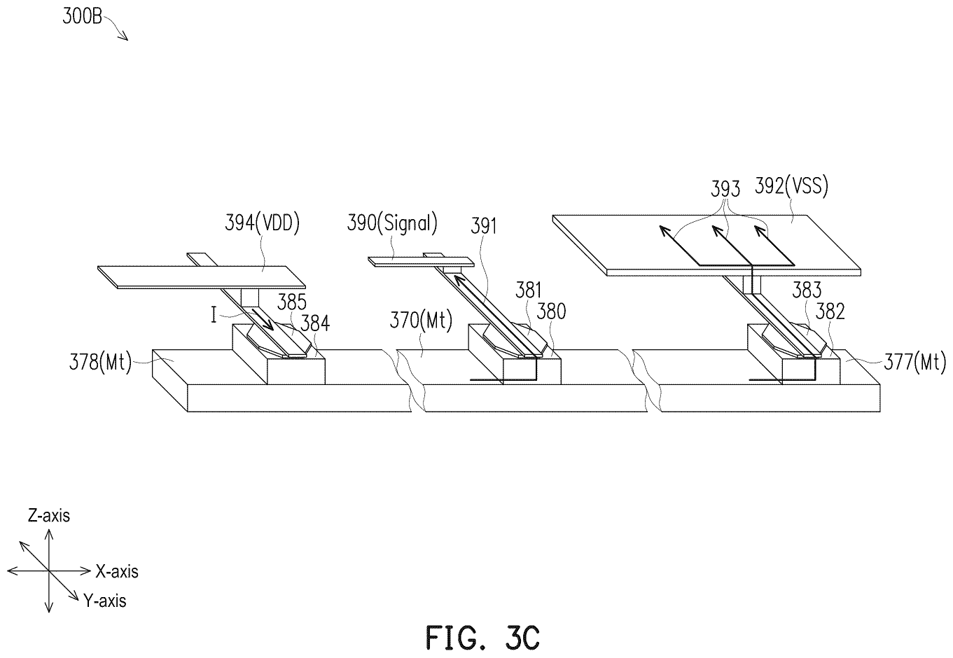

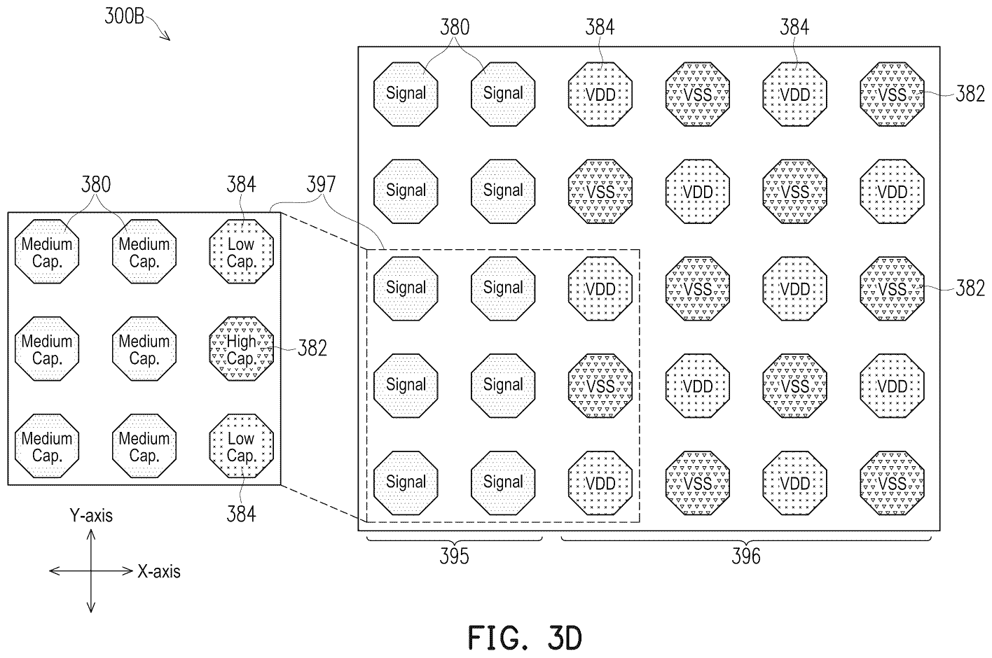

In some embodiments, the thermal analysis 150 is performed by an EDA tool. For example, the thermal analysis 150 is performed by one or more EDA tools that perform the IC design flow 100. In at least one embodiment, the thermal analysis 150 is performed by a separate computer system or processor outside the EDA tools that perform the IC design flow 100. In some embodiments, the thermal analysis 150 comprises at least one of a static thermal analysis or a transient thermal analysis. In at least one embodiment, the thermal analysis 150 comprises a full-chip thermal analysis for the whole IC device being designed. In some embodiments, the thermal analysis 150 comprises a partial thermal analysis for a portion, rather than an entirety, of the IC device being designed. In some embodiments, a result of the thermal analysis 150 comprises a thermal report including at least one of a temperature gradient, a heat distribution, a temperature map (or temperature distribution), or the like, of the IC device being designed. Based on the thermal report, it is possible to determine whether the IC device being designed meets one or more thermal requirements, or not. For example, if a temperature map in the thermal report indicates that the IC device, or a circuit region thereof, is overheated (i.e., there is/are one or more hot spot regions in the IC device), a modification is made to the IC layout, either directly or indirectly, at modification operation 108, as described herein. In some embodiments, even when the thermal report indicates that the thermal requirements are satisfied, the IC layout is still modified to make thermal improvements, e.g., to achieve a more uniform heat distribution either globally throughout the IC device, or locally in one or more circuit regions thereof. As a result, it is possible in one or more embodiments to avoid, or at least mitigate, heat-related performance and/or reliability issues, such as excessive IR-drops, long delays, poor signal integrity, undesirable electromigration effects, or the like. When thermal requirements are satisfied, and any thermal improvements have been made, the IC layout is subject to a subsequent verification or is output to manufacturing operation 110. Details of the thermal analysis 150 in accordance with some embodiments are described with respect to FIGS. 3A-8B.

At modification operation 108, one or more modifications are made to the IC layout based on the results of one or more verifications in the verification operation 106, as described herein. Examples of modifications made based on a result of the thermal analysis 150 include, but are not limited to, changes in number, structure, location, material properties, or the like, of thermally significant features. In an example, additional vias and/or conductive patterns (or nets) are added to a hot spot region of the IC layout to increase the heat dissipation capability of the region. In a further example, one or more dimensions, e.g., width, length, thickness, or the like, of one or more conductive patterns and/or vias in a hot spot region of the IC layout are increased to increase the heat dissipation capability of the region. In another example, one or more cells, which are heat sources in operation, are moved out of a hot spot region, or are replaced with corresponding cells having the same electrical/logical functionality but with lower heating power or heat generation capability. In yet another example, a different conductive material, e.g., another metal with a high thermal conductivity, is used instead of the original conductive material, to form vias and/or conductive patterns in a hot spot region. Other modifications to satisfy thermal requirements and/or to achieve thermal improvements are within the scopes of various embodiments.

Once one or more modifications have been made to the IC layout, one or more verifications at the verification operation 106 are performed again to ensure that the modified IC layout satisfies all design rules, timing requirements, thermal requirements, or the like. In some situations, the described modification-verification process is repeated one or more times until it is determined that the IC layout is ready for manufacture and the process proceeds to the manufacturing operation 110, or it is determined that the IC layout despite the modifications does not satisfy all requirements and needs to be redesigned. The IC design flow 100 in FIG. 1 is an example. In some embodiments, the IC device design flow 100 includes one or more further operations, and/or one or more of the described operations are omitted.

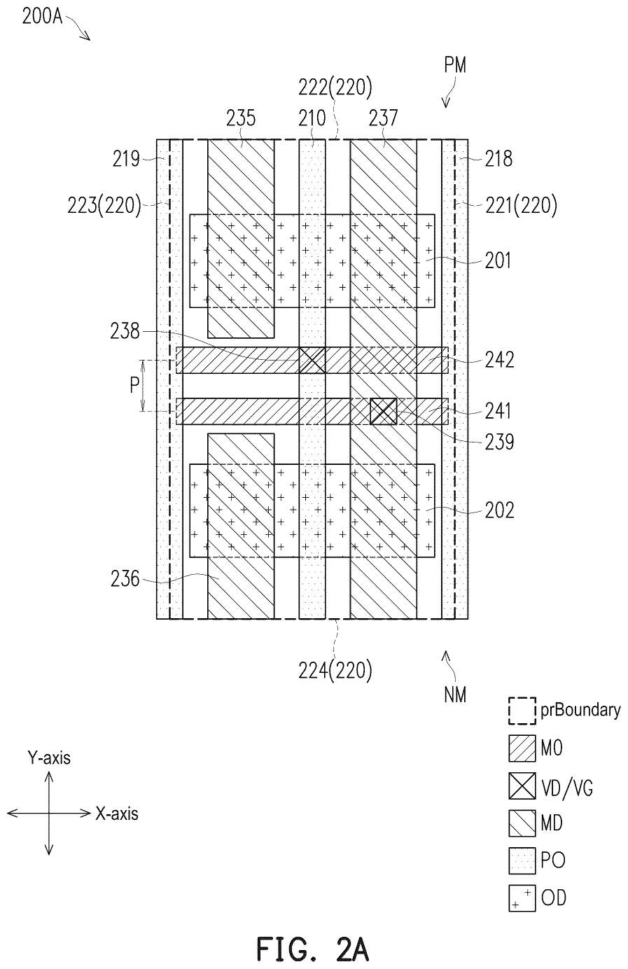

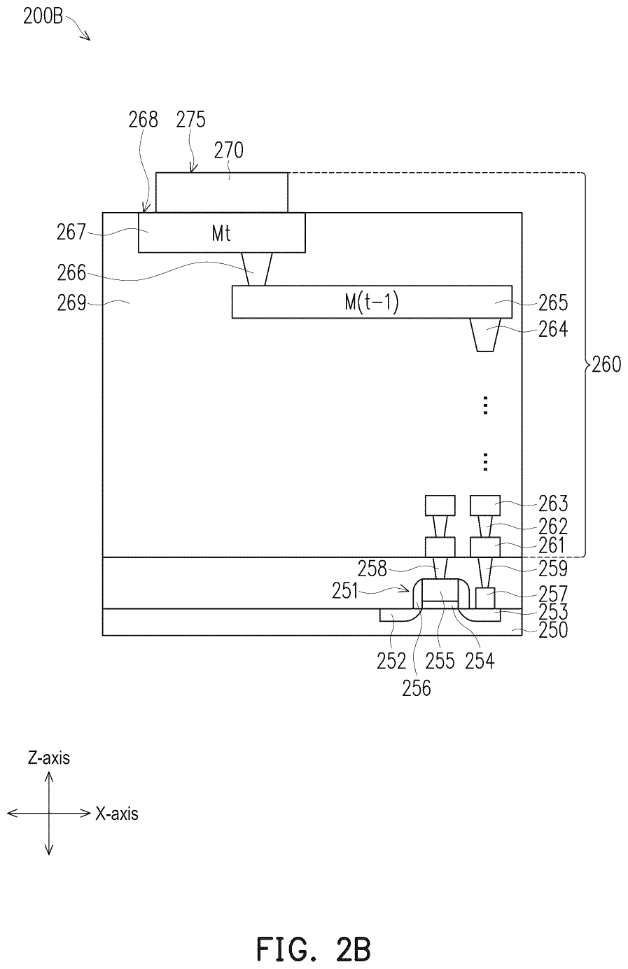

FIG. 2A is a schematic view of a layout of an example cell 200A, in accordance with some embodiments. In at least one embodiment, the layout of the cell 200A in FIG. 2A is stored as a standard cell in a standard cell library on a non-transitory computer-readable storage medium.

In FIG. 2A, the cell 200A comprises active regions 201, 202, a gate region 210, and a boundary 220. The active regions 201, 202 are arranged inside the boundary 220, and extend along a first axis, i.e., X-axis. Active regions are sometimes referred to as oxide-definition (OD) regions, and are schematically illustrated in the drawings with the label “OD.” The active regions 201, 202 include P-type dopants and/or N-type dopants to form one or more circuit elements or devices. The gate region 210 is arranged inside the boundary 220, and extends across the active regions 201, 202 along a second axis, i.e., Y-axis, which is transverse to the X-axis. In at least one embodiment, the Y-axis is perpendicular to the X-axis. The gate region 210 includes a conductive material, such as, polysilicon, and is schematically illustrated in the drawings with the label “PO.” Other conductive materials for the gate region, such as metals, are within the scope of various embodiments. In the example configuration in FIG. 2A, the active region 201 is configured to form, together with the gate region 210, a p-channel metal-oxide semiconductor (PMOS) transistor PM, and the active region 202 is configured to form, together with the gate region 210, a n-channel metal-oxide semiconductor (NMOS) transistor NM.

The boundary 220 comprises edges 221, 222, 223, 224 connected together to form a closed boundary. In the cell placement and routing operation 104 described herein, cells are placed in an IC layout in abutment with each other at their respective boundaries. For example, the cell 200A is placed in abutment with one or more other cells along the X-axis at one or more of the edges 221, 223. Additionally or alternatively, the cell 200A is placed in abutment with one or more other cells along the Y-axis at one or more of the edges 222, 224. The boundary 220 is sometimes referred to as “place-and-route boundary” and is schematically illustrated in the drawings with the label “prBoundary.” The cell 200A further comprises, along the corresponding edges 221, 223 of the boundary 220, dummy gate regions 218, 219 which are not configured to form transistors together with the underlying active regions.

The cell 200A further comprises contact structures 235, 236, 237 over and in electrical contact with the corresponding source/drain regions in the active regions 201, 202. Contact structures are sometimes referred to as metal-to-device structures, and are schematically illustrated in the drawings with the label “MD.” An MD contact structure includes a conductive material formed over a corresponding source/drain region in the corresponding active region to define an electrical connection from one or more devices formed in the active region to other circuitry. An example conductive material of MD contact structures includes metal. Other configurations are within the scopes of various embodiments.

The cell 200A further comprises vias over and in electrical contact with the corresponding gate regions or MD contact structures. A via over and in electrical contact with an MD contact structure is sometimes referred to as via-to-device (VD). A via over and in electrical contact with a gate region is sometimes referred to as via-to-gate (VG). VD and VG vias are schematically illustrated in the drawings with the label “VD/VG.” In the example configuration in FIG. 2A, a VG via 238 is over and in electrical contact with the gate region 210, and a VD via 239 is over and in electrical contact with the MD contact structure 237. An example material of the VD and VG vias includes metal. Other configurations are within the scopes of various embodiments.

The cell 200A further comprises one or more metal layers and via layers sequentially and alternatingly arranged over the VD and VG vias. The lowermost metal layer immediately over and in electrical contact with the VD and VG vias is a metal-zero (M0) layer. In other words, the M0 layer is the lowermost metal layer over the active regions 201, 202, or the closest metal layer to the circuit devices, such as, the transistors PM, NM. A next metal layer immediately over the M0 layer is a metal-one (M1) layer, or the like. A via layer Vn is arranged between and electrically couple the Mn layer and the Mn+1 layer, where n is an integer form zero and up. For example, a via-zero (V0) layer is the lowermost via layer which is arranged between and electrically couple the M0 layer and the M1 layer. Other via layers are V1, V2, or the like. Metal layers, such as M0, M1, or the like, and via layers, such as V0, V1, or the like, together form a redistribution structure, and are sometimes referred to as back-end-of-line (BEOL) layers. The circuit devices are sometimes referred to as a front-end-of-line (FEOL) layer. In the example configuration in FIG. 2A, the cell 200A comprises, in the M0 layer, M0 conductive patterns 241, 242. The M0 conductive pattern 241 overlaps and is electrically coupled to the VD via 239, and the M0 conductive pattern 242 overlaps and is electrically coupled to the VG via 238. The M0 conductive patterns 241, 242 are immediately adjacent each other, and is spaced from each other by a metal pitch p of the metal layer M0. In the example configuration in FIG. 2A, the metal pitch p is a center-to-center distance between the M0 conductive patterns 241, 242. Other definitions of metal pitch are within the scopes of various embodiments. In at least one embodiment, e.g., when the cell 200A comprises more complex circuitry, additional conductive patterns of one or more other/higher metal layers and/or additional vias of one or more other/higher via layers are included in the cell 200A. In a routing operation, an APR tool is configured to generate vias and conductive patterns in the metal layers and via layer over the metal layer M0 to couple the cell 200A with other cells and/or with external circuitry.

FIG. 2B is a schematic cross-sectional view of a portion of an IC device 200B, in accordance with some embodiments.

The IC device 200 comprises a substrate 250 over which various circuit devices of the IC device 200B is formed. An example circuit device, i.e., a transistor 251, is illustrated in FIG. 2B. The transistor 251 corresponds to the transistor PM or NM described with respect to FIG. 2A. The transistor 251 comprises source/drain regions 252, 253 which are P-doped or N-doped regions formed by P-type or N-type dopants added to the substrate 250. In some embodiments, P-doped or N-doped regions are formed in N-wells or P-wells. In some embodiments, isolation structures are formed between adjacent P well/P-doped regions and N well/N-doped regions. For simplicity, isolation structures are omitted from FIG. 2B. The transistor 251 further comprises a gate stack including a gate dielectric layer 254, and a gate electrode 255. In at least one embodiment, the gate dielectric layer comprises multiple gate dielectric layers. Example materials of the gate dielectric layer or layers include HfO2, ZrO2, or the like. Example materials of the gate electrode 255 include polysilicon, metal, or the like. Spacers 256 are formed on sidewalls of the gate stack. Example materials of the spacers 256 include, but are not limited to, silicon nitride, oxynitride, silicon carbide, or the like. MD contact structures are formed over the source/drain regions of the transistor 251 to define an electrical connection from the transistor 251 to other circuit elements. In FIG. 2B, a MD contact structure 257 is illustrated as being over and electrically coupled to the source/drain region 253. A VG via 258 is over and in electrical contact with the gate region 255. A VD via 259 is over and in electrical contact with the MD contact structure 257.

The IC device 200B further comprises a redistribution structure 260 over the substrate 250 along a thickness direction of the substrate 250, which is also a thickness direction of the IC device 200B and is indicated as Z-axis in FIG. 2B. The redistribution structure 260 comprises a plurality of metal layers M0, M1, or the like, and via layers, V0, V1, or the like, sequentially and alternatingly arranged over the VD, VG vias along the Z-axis. For example, an M0 conductive pattern 261 is over and in electrical contact with the VD via 259, a V0 via 262 is over and in electrical contact with the M0 conductive pattern 261, an M1 conductive pattern 263 is over and in electrical contact with the V0 via 262, or the like. At the upper portion of the redistribution structure 260, a via 264 is electrically coupled to the M1 conductive pattern 263, an M(t−1) conductive pattern 265 is over and in electrical contact with the via 254, a via 266 is over and in electrical contact with the M(t−1) conductive pattern 265, and an Mt conductive pattern 267 is over and in electrical contact with the via 266. The Mt conductive pattern 267 belongs to a top metal layer Mt which is the topmost metal layer of the redistribution structure 260. The redistribution structure 260 further comprises an interlayer dielectric (ILD) 269 in which the metal layers and via layers are embedded.

The redistribution structure 260 further comprises a plurality of off-chip interconnects over the top metal layer Mt of the redistribution structure 260. An example off-chip interconnect 270 is illustrated in FIG. 2B, and is over and in electrical contact with the Mt conductive pattern 267. An off-chip interconnect is configured to provide an electrical connection of the IC device 200B with external circuitry, e.g., with conductive lines on a motherboard, on another chip, on a chip package, or the like. Examples of off-chip interconnects include, but are not limited to, under-bump-metallurgy (UBM) structures, contact pads, solder balls or bumps, micro-bumps, metal pillars, bonding pads, or the like. For simplicity, off-chip interconnects are sometimes referred to herein as pins, e.g., power supply pins, ground pins, input/output (I/O) pins, or the like. For example, a power supply pin is an off-chip interconnect configured to be coupled to a power supply voltage line of the external circuitry, which power supply voltage line has a positive power supply voltage. A ground pin is an off-chip interconnect configured to be coupled to a ground voltage line of the external circuitry, which ground voltage line has the ground voltage (or a reference voltage other than the ground voltage). The power supply voltage line and the ground voltage line are configured to provide power supply to the IC device 200B, and are sometimes referred to commonly as power rails. An I/O pin or signal pin is an off-chip interconnect configured to be coupled to a signal line of the external circuitry, which signal line is configured to input signals into the IC device 200B, or to receive signals from the IC device 200B. Example signals include, but are not limited to, data, clock, control, or the like.

The metal layers and via layers in the redistribution structure 260 are sometimes referred to herein commonly as conductive layers. The conductive layers are configured to not only form electrical paths for power, clock, data, or the like, but also to form heat dissipation paths for dissipating heat generated by circuit devices of the IC device during operation. For example, the transistor 251, in operation, generates heat, i.e., becomes a heat source. The heat generated by the transistor 251 is propagated through the electrically coupled conductive patterns and vias in the conductive layers of the redistribution structure 260 to the off-chip interconnect 270. The off-chip interconnect 270 has an interface 275, e.g., the upper surface of the off-chip interconnect 270, through which the off-chip interconnect 270 is electrically coupled to a conductive line of the external circuitry. The interface 275 also functions as a thermal interface through which the heat propagated from one or more circuit devices to the off-chip interconnect 270 is dissipated outside the IC device 200B. The IC device 200B has further thermal interfaces for dissipating heat to the external environment, such as, a top surface 268 of the top metal layer Mt, the substrate 250, or the like. Depending on the connectivity of the off-chip interconnect 270 with the external circuitry, e.g., depending on whether the off-chip interconnect 270 is a power supply pin, a ground pin, a signal pin, or the like, the conductive line of the external circuitry to be coupled to the off-chip interconnect 270 has a different configuration, e.g., in terms of one or more of dimension, shape, metal property, or the like. Different configurations of conductive lines of the external circuitry correspond to different heat dissipation capabilities of the corresponding off-chip interconnects of the IC device 200B.

During the design stage before the IC device 200B is manufactured, an IC layout of the IC device 200B is subject to various verifications as described herein, including a thermal analysis such as the thermal analysis 150. In a thermal analysis in accordance with some embodiments, models of the conductive layers in the redistribution structure 260 are generated or determined, and boundary conditions corresponding to heat dissipation capabilities are assigned to thermal interfaces of the IC device 200B. The models and boundary conditions are then used in a thermal simulation for the IC device 200B to determine a thermal profile of the IC device 200B in operation, including, e.g., a heat distribution, a temperature map, or the like. In at least one embodiment, by customizing how the models are generated and/or how boundary conditions are assigned, it is possible to achieve a desired accuracy for the thermal analysis at an acceptable runtime or processing (computation) requirements.

FIG. 3A is a flowchart of a thermal analysis 300A, in accordance with some embodiments. FIG. 3B is a schematic perspective view of a portion of an IC device 300B modeled in a thermal analysis, in accordance with some embodiments. FIG. 3C is a schematic perspective view and FIG. 3D is a schematic plan view of a portion of the IC device 300B with various boundary conditions assigned in a thermal analysis, in accordance with some embodiments. Corresponding components in FIGS. 3B-3D are designated by the same reference numerals. In some embodiments, the thermal analysis 300A in FIG. 3A corresponds to the thermal analysis 150 and/or is performed at least in part by at least one processor as described herein.

In FIG. 3A, at operation 302, the processor is configured to receive an IC layout as input data for the thermal analysis 300A. For example, the IC layout is received from an APR tool that performs a cell placement and routing operation to generate the IC layout, as described with respect to FIG. 1. In some embodiments, the IC layout includes data in at least one of the GDSII file format, the DEF file format, or the LEF file format. Other manners and/or file formats for inputting data of an IC layout for the thermal analysis 300A are within the scopes of various embodiments. In at least one embodiment, the data input for the thermal analysis 300A further comprises connectivity with external circuitry for at least one off-chip interconnect of a redistribution structure in the IC layout. The connectivity is used by the processor in one or more embodiments to assign an appropriate boundary condition to the off-chip interconnect. In some embodiments, the connectivity of one or more off-chip interconnects of the IC layout is included in an IC schematic described with respect to FIG. 1, and the IC schematic is input to the thermal analysis 300A at operation 302.

FIG. 3B is a schematic perspective view of a portion of the IC device 300B which is an example IC device corresponding to the IC layout for which the thermal analysis 300A in accordance with some embodiments is performed. The IC layout, or the corresponding IC device 300B, comprises circuit devices. For example, the IC device 300B comprises a substrate 330 having active regions 332, 333, a gate region 355, and MD contact structures 336, 337 formed thereover. The active regions 332, 333 and the gate region 355 configure one or more circuit devices (not numbered) of the IC device 300B. In some embodiments, the substrate 330 corresponds to the substrate 250, the active regions 332, 333 correspond to the active regions 201, 202 and/or the source/drain regions 252, 253, the gate region 355 corresponds to the gate region 210 and/or the gate electrode 255, and the MD contact structures 336, 337 correspond to the MD contact structures 235, 236, 237 and/or the MD contact structure 257.

The IC layout, or the corresponding IC device 300B, further comprises a redistribution structure (not numbered) over the circuit devices, and the redistribution structure comprises a plurality of conductive layers stacked one upon another in a thickness direction of the substrate 330. In some embodiments, the redistribution structure of the IC device 300B corresponds to the redistribution structure 260, and comprises a bottom metal layer M0, a middle metal layer Mm, and a top metal layer Mt correspondingly having M0 conductive pattern 350, Mm conductive pattern 360, and Mt conductive pattern 370. A VD via 345 electrically couples the MD contact structure 337 to the M0 conductive pattern 350. A via 346 electrically couples the M0 conductive pattern 350 to the Mm conductive pattern 360, and a via 347 electrically couples the Mm conductive pattern 360 to the Mt conductive pattern 370. In some embodiments, one or more additional metal layers and via layers exist between the metal layer M0 and the middle metal layer Mm, and/or between the middle metal layer Mm and the top metal layer Mt. Such additional metal layers and via layers are omitted in FIG. 3B for simplicity, and are schematically represented by the vias 346, 347. The redistribution structure of the IC device 300B further comprises a plurality of off-chip interconnects over and in electrical contact with conductive patterns in the top metal layer Mt. An example off-chip interconnect 380 is illustrated in FIG. 3B as being over and in electrical contact with the Mt conductive pattern 370. In at least one embodiment, the off-chip interconnect 380 corresponds to the off-chip interconnect 270, or any off-chip interconnect of the IC device 200B. The off-chip interconnect 380 has thereon a bump 381 corresponding to an interface through which the off-chip interconnect 380 is configured to be electrically coupled to a conductive line of external circuitry. Other configurations for the off-chip interconnect 380 and/or its interface for external circuitry are within the scopes of various embodiments.

In FIG. 3A, between operation 304 and operation 312, for each conductive layer in the redistribution structure, the processor is configured to determine, among one or more conditions, which condition is satisfied by the conductive layer. The processor is further configured to apply a corresponding modeling rule to the conductive layer based on the satisfied condition.

Specifically, at operation 306, the processor is configured to determine whether a property of the current conductive layer satisfies a first condition. In response to the property of the current conductive layer satisfying the first condition (Yes from operation 306), the process proceeds to operation 307 where the processor is configured to apply a corresponding first modeling rule to the current conductive layer to obtain a model of the current conductive layer.

In response to the property of the current conductive layer not satisfying the first condition (No from operation 306), the process proceeds to operation 308 where the processor is configured to determine whether the property of the current conductive layer satisfies a second condition. In response to the property of the current conductive layer satisfying the second condition (Yes from operation 308), the process proceeds to operation 309 where the processor is configured to apply a corresponding second modeling rule to the current conductive layer to obtain a model of the current conductive layer.

In response to the property of the current conductive layer not satisfying the second condition (No from operation 308), the process proceeds to operation 310 where the processor is configured to determine whether the property of the current conductive layer satisfies a third condition. In response to the property of the current conductive layer satisfying the third condition (Yes from operation 310), the process proceeds to operation 311 where the processor is configured to apply a corresponding third modeling rule to the current conductive layer to obtain a model of the current conductive layer.

In response to the property of the current conductive layer not satisfying the third condition (No from operation 310), the process proceeds to consider a next condition (not shown) to determine whether a corresponding next modeling rule (not shown) is to be applied to the current conductive layer, in a similar manner to that described with respect to operations 306-311. Any number of conditions and modeling rules are within the scopes of various embodiments. In at least one embodiment, the conditions, including the first through third conditions, are different from each other, and the modeling rules including the first through third modeling rules, are different from each other.

After each of operations 307, 309, 311, or the like, i.e., after applying a corresponding modeling rule to the current conductive layer, the process proceeds to operation 312 where the processor is configured to determine whether there is a remaining conductive layer among the plurality of conductive layers of the redistribution structure. If one or more conductive layers remain, the process returns to operation 304 where a next conductive layer among the remaining layers is considered to determine the corresponding modeling rule to be applied to the next conductive layer.

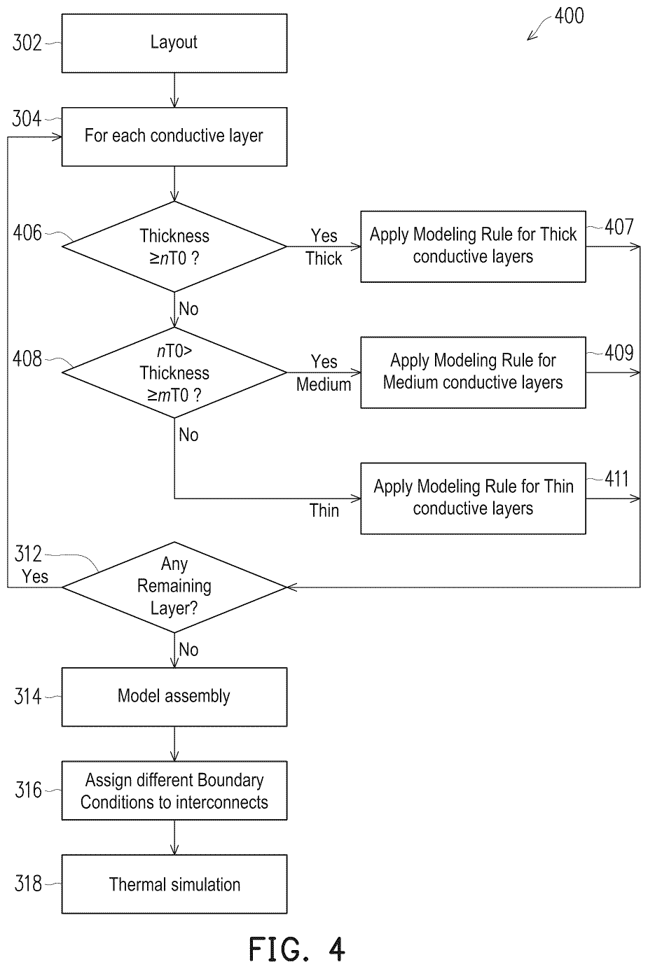

In at least one embodiment, the property of the conductive layer to be considered in operations 306, 308, 310, or the like, includes a physical property of the conductive layer. For example, when the conductive layer is a metal layer, the physical property comprises at least one of a thickness of the metal layer, a width of a conductive pattern in the metal layer, a length of a conductive pattern in the metal layer, or a metal pitch of the metal layer. When the conductive layer is a via layer, the physical property comprises at least one of a thickness of the via layer, a width of a via in the via layer, or a via pitch of the via layer. In at least one embodiment, like the metal pitch described with respect to FIG. 2A, a via pitch of a via layer is a center-to-center distance between two immediately adjacent vias in the via layer. Example embodiments where the property to be considered comprises a thickness and/or a width of a metal layer are described with respect to FIGS. 4, 5A-5C, 8A-8B.

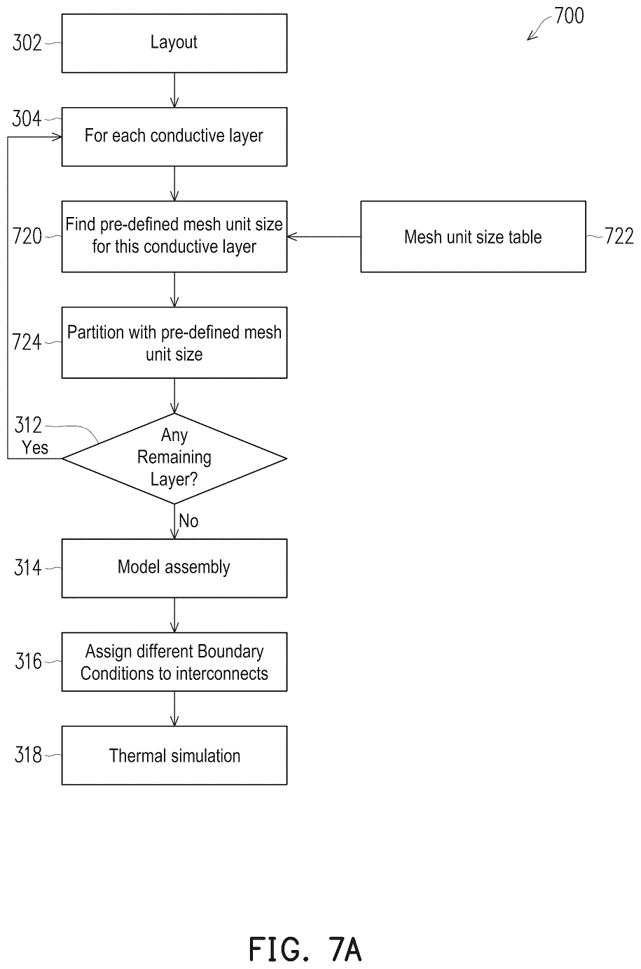

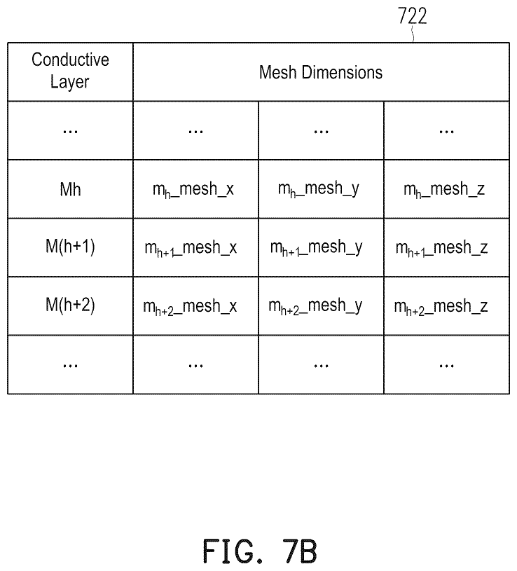

In at least one embodiment, the property to be considered in operations 306, 308, 310, or the like, is different from a physical property of the conductive layer. In one or more embodiments, the property to be considered includes a position of the conductive layer in the redistribution structure. For example, the metal layer M0 is the bottom layer of the redistribution structure and corresponds to a first modeling rule, whereas the metal layer M1 is the second layer from the bottom and corresponds to a different, second modeling rule, or the like. For another example, a first set of metal layers including the metal layer M0 corresponds to a first modeling rule, whereas a second set of metal layers over the first set corresponds to a different, second modeling rule, or the like. In various situations, lower metal layers often have smaller thickness, width and/or pitch than upper metal layers, and therefore, considering the position of a metal layer in the redistribution structure is comparable to considering a physical property of the metal layer. However, in at least one embodiment, a thermal analysis considering the position of a metal layer in the redistribution structure does not need to know specific physical properties, e.g., thickness, width, pitch, of the metal layer, and is therefore applicable to various IC layout regardless of specific manufacturing nodes or processes to be used. One or more example embodiments where the property to be considered comprises the position of a metal layer in the redistribution structure are described with respect to FIGS. 7A-7B.

In at least one embodiment, the property to be considered in operations 306, 308, 310, or the like, comprises a metal property of the conductive layer. Sample metal properties include, but are not limited to, physical dimensions, resistivity, thermal conductivity, or the like. Examples of physical dimensions include, but are not limited to, the thickness of a metal layer along the Z axis, a width of a conductive pattern in the metal layer along one of the X axis and the Y axis, a length of a conductive pattern in the metal layer along the other of the X axis and the Y axis, or the like. For example, if the thickness of the metal layer is less than a predetermined thickness, conductive patterns in the metal layer are partitioned in accordance with fine-grain partitioning as described herein. If the thickness of the metal layer is not less than the predetermined thickness, conductive patterns in the metal layer are partitioned in accordance with coarse-grain partitioning as described herein. Alternatively or additionally, if the width or length of conductive patterns in the metal layer is less than a predetermined width or length, conductive patterns in the metal layer are partitioned in accordance with fine-grain partitioning. If the width or length of conductive patterns in the metal layer is not less than the predetermined width or length, conductive patterns in the metal layer are partitioned in accordance with coarse-grain partitioning. In a further example, if a thermal conductivity of a metal of the metal layer is lower than a predetermined thermal conductivity, conductive patterns in the metal layer are partitioned in accordance with coarse-grain partitioning. If the thermal conductivity of the metal of the metal layer is not lower than a predetermined thermal conductivity, conductive patterns in the metal layer are partitioned in accordance with fine-grain partitioning.

In some embodiments, the modeling rules for modeling various conductive layers as described with respect to operations 307, 309, 311, or the like, are different from each other in at least one of modeling approach, partitioning resolution, or partitioning style. In some embodiments, a first modeling approach comprises partitioning a conductive layer into meshes (or grids), whereas a second modeling approach comprises a simpler model in which overall thermal conductivity of a conductive layer is calculated based on a metal density of the conductive layer. As described herein with respect to FIG. 3B, the top metal layer Mt and middle metal layer Mm are modeled in accordance with the first modeling approach (i.e., with meshes), whereas the metal layer M0 is modeled in accordance with the second modeling approach (i.e., with metal density).

In some embodiments where one or more conductive layers are modeled by being partitioned into meshes, modeling rules applied to such conductive layers have different partitioning resolutions, e.g., with fine-grain partitioning versus coarse-grain partitioning, and/or with a large mesh unit size versus a small mesh unit size, or the like. As described herein with respect to FIG. 3B, the top metal layer Mt and the middle metal layer Mm are modeled in accordance with the same first modeling approach (i.e., with meshes) but at different partitioning resolutions and/or mesh unit sizes.

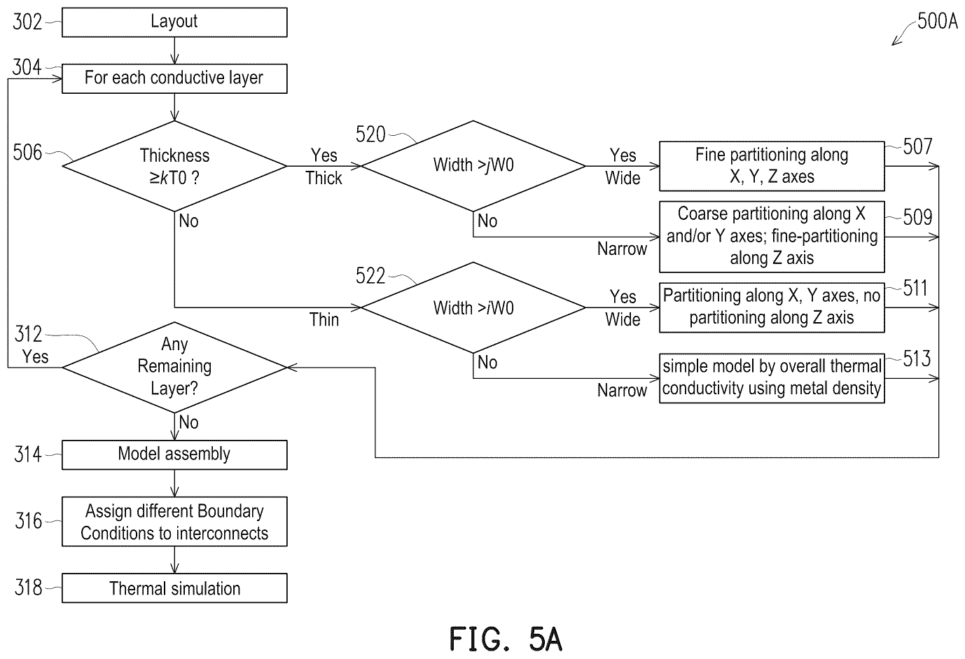

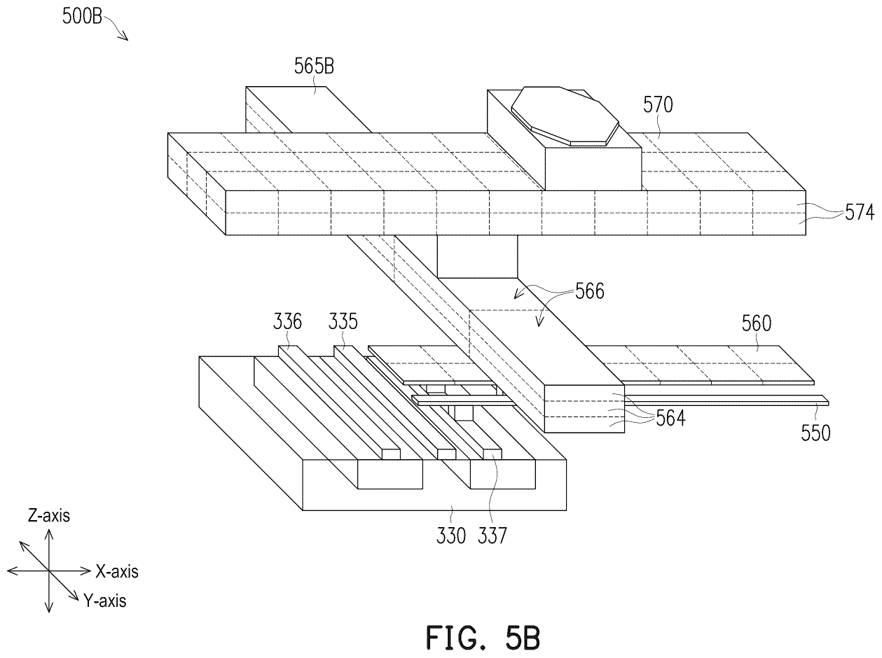

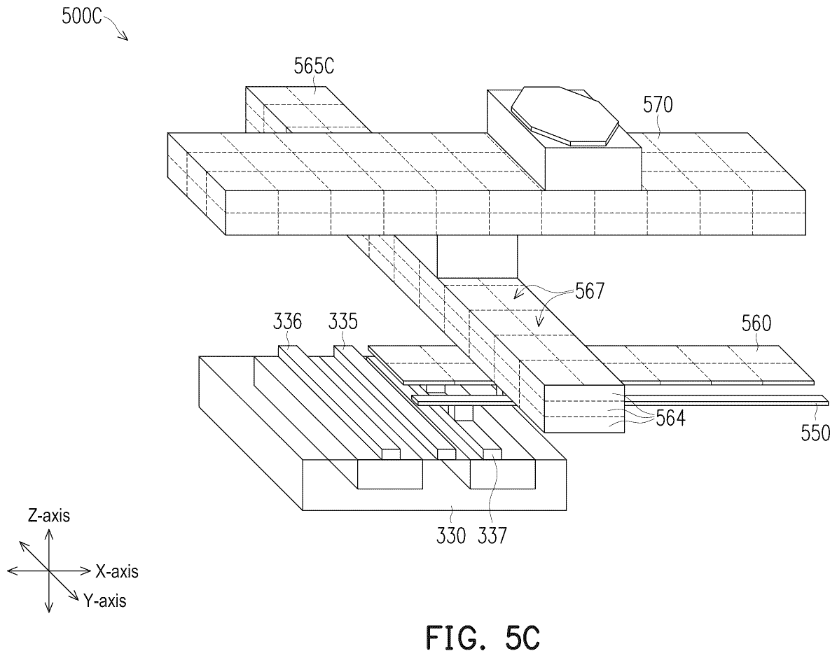

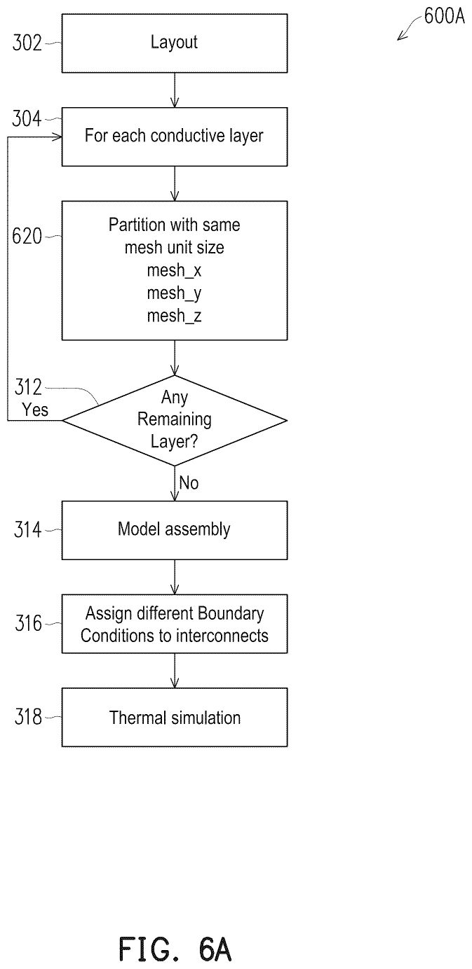

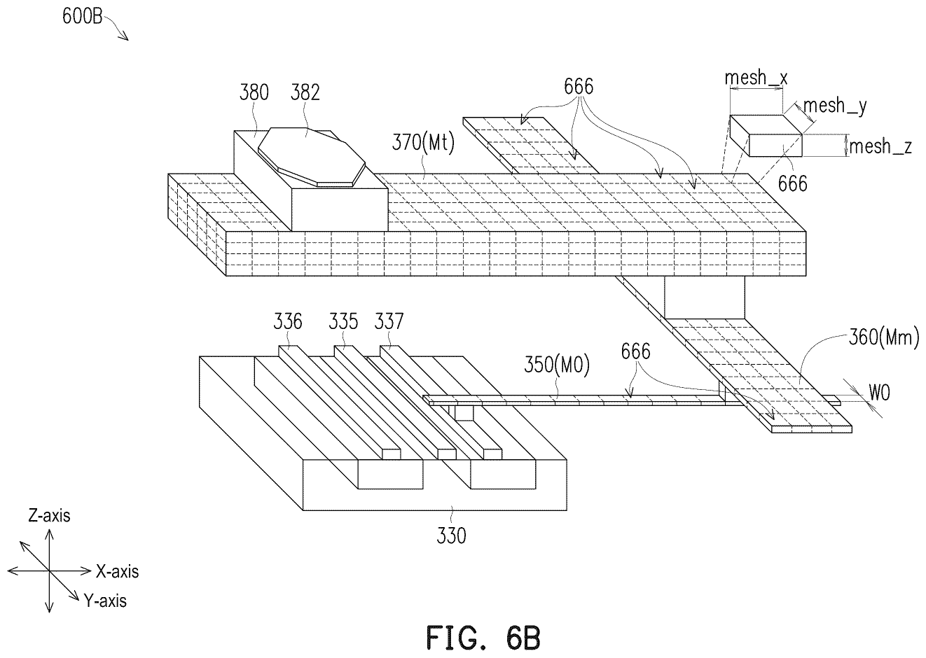

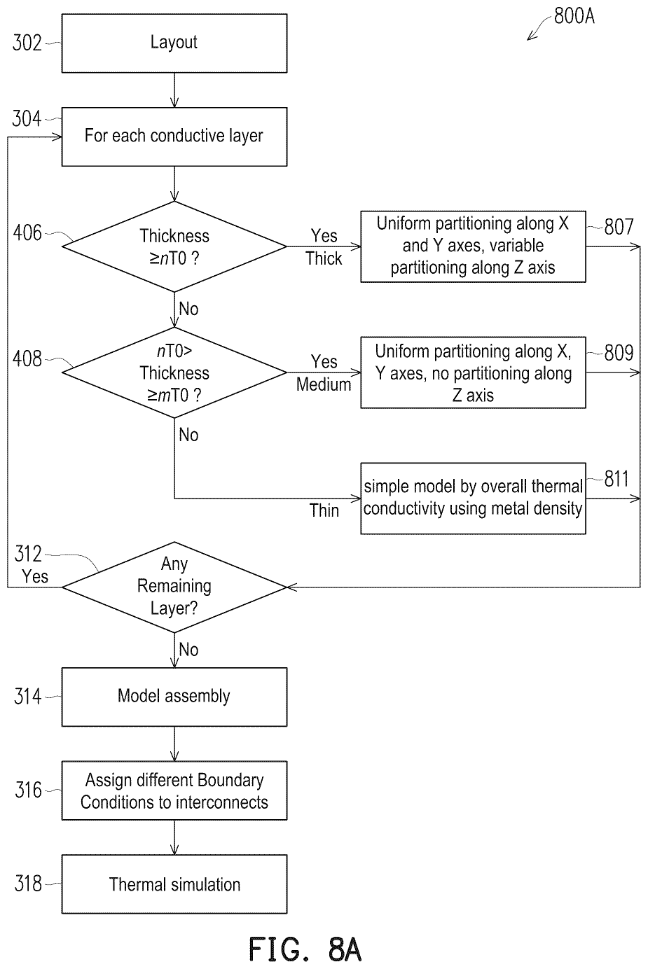

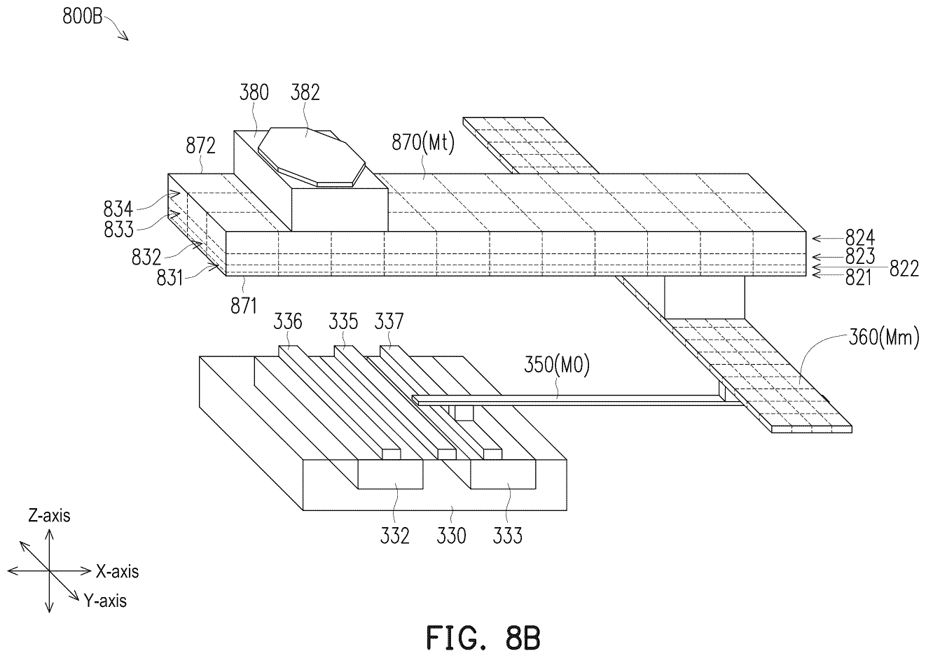

In some embodiments where one or more conductive layers are modeled by being partitioned into meshes, modeling rules applied to such conductive layers have different partitioning styles. A first partitioning style in accordance with some embodiments comprises a pre-defined, fixed mesh unit size for all conductive layers, for example, as described with respect to FIGS. 6A-6B. A second partitioning style in accordance with some embodiments comprises layer-dependent pre-defined fixed mesh unit sizes, for example, as described with respect to FIGS. 7A-7B. A third partitioning style in accordance with some embodiments comprises a uniform mesh unit size in each conductive layer, for example, as described with respect to FIGS. 4, 5A-5C. A fourth partitioning style in accordance with some embodiments comprises variable mesh unit sizes in a conductive layer, for example, as described with respect to FIGS. 8A-8B. Other partitioning styles are within the scopes of various embodiments.

In some embodiments, to achieve a desired accuracy for a thermal analysis at one or more thicker conductive layers at an upper part of the redistribution structure, such thicker conductive layers are partitioned into meshes which are later used in a thermal simulation as described herein. In at least one embodiment, to balance the accuracy and runtime, the thicker conduction layers are partitioned into meshes with different partitioning resolutions and/or partitioning styles, based on one or more properties of the conductive layers. In some embodiments, one or more thinner conductive layers at a lower part of the redistribution structure are modeled with a simpler modeling approach, e.g., by using metal densities of the thinner conductive layers. The simpler modeling approach reduces runtime of the thermal analysis at the thinner conductive layers, without significantly sacrificing accuracy.

FIG. 3B includes examples how various conductive layers are modeled, in one or more embodiments. For example, the top metal layer Mt has a thickness T1 that satisfies a first condition (e.g., T1>first thickness threshold), and a corresponding first modeling rule is applied to model the top metal layer Mt. In accordance with the first modeling rule, the top metal layer Mt is partitioned in all three directions, i.e., width, length and thickness directions. For example, the Mt conductive pattern 370 is partitioned, by partitioning lines 371, 372, 373, into a mesh of a plurality of mesh units 376. The partitioning lines 371 extend along the Y axis which is a width direction of the Mt conductive pattern 370. The partitioning lines 372 extend along the X axis which is a length direction of the Mt conductive pattern 370. The partitioning line 373 divides the Mt conductive pattern 370 in the thickness direction into two layers 374, 375 of mesh units 376. In the example configuration in FIG. 3B, the mesh units 376 have the same mesh unit size, i.e., a length Lu1, a width Wu1, and a thickness Tu1. In some embodiments, a width of a conductive pattern in the top metal layer Mt, e.g., a width W1 of the Mt conductive pattern 370, is considered in lieu of, or in addition to, the thickness T1 to determine the applicable modeling rule, as described with respect to operations 306, 308, 310.

The middle metal layer Mm has a thickness T2 that satisfies a second condition (e.g., first thickness threshold≥T2>second thickness threshold), and a corresponding second modeling rule is applied to model the middle metal layer Mm. In accordance with the second modeling rule, the middle metal layer Mm is partitioned in two directions, i.e., width and length directions. For example, the Mm conductive pattern 360 is partitioned, by partitioning lines 361, 362, into a mesh of a plurality of mesh units 366. The partitioning lines 361 extend along the X axis which is a width direction of the Mm conductive pattern 360. The partitioning lines 362 extend along the Y axis which is a length direction of the Mm conductive pattern 360. The mesh of the Mm conductive pattern 360 has a single layer 364 of mesh units 366. In the example configuration in FIG. 3B, the mesh units 366 have the same mesh unit size, i.e., a length Lu2, a width Wu2, and a thickness Tu2. In some embodiments, a width of a conductive pattern in the middle metal layer Mm, e.g., a width W2 of the Mm conductive pattern 360, is considered in lieu of, or in addition to, the thickness T2 to determine the applicable modeling rule, as described with respect to operations 306, 308, 310.

Although both the top metal layer Mt and middle metal layer Mm are modeled in accordance with the same first modeling approach (i.e., with meshes), the corresponding modeling rules differ in partitioning resolutions and/or mesh unit sizes. For example, the top metal layer Mt is partitioned in the thickness direction into two layers 374, 375 of mesh units 376, whereas the middle metal layer Mm is not partitioned in the thickness direction and includes a single layer 364 of mesh units 366. In other words, the partitioning resolution for the top metal layer Mt is higher than that of the middle metal layer Mm at least along the thickness direction. In at least one embodiment, the thickness T1 of the top metal layer Mt being greater than the thickness T2 of the middle metal layer Mm is a reason for partitioning the top metal layer Mt at a higher partitioning resolution at least along the thickness direction, to ensure a desired accuracy for the thermal analysis.

In the example configuration in FIG. 3A, the mesh units 376 for the top metal layer Mt and the mesh units 366 for the middle metal layer Mm have different mesh unit sizes. Specifically, the length Lu1, width Wu1 and thickness Tu1 of each mesh unit 376 are correspondingly larger than the length Lu2, width Wu2 and thickness Tu2 of each mesh unit 366. This is an example, and other differences in mesh unit size are within the scopes of various embodiments. For example, in one or more embodiments, each mesh unit 376 has a dimension (e.g., length Lu1) larger than a corresponding dimension (e.g., length Lu2) of each mesh unit 366, and another dimension (e.g., width Wu1) smaller than a corresponding dimension (e.g., width Wu2) of each mesh unit 366.

In some embodiments, a modeling rule controls whether a conductive layer is to be partitioned in a direction (e.g., length direction, width direction, thickness direction) and, if it is to be partitioned, at which mesh unit size or at which partitioning resolution. For example, as the length Lu1 of each mesh unit 376 is increased, a partitioning resolution of the Mt conductive pattern 370 along the length direction (X axis) is decreased, the runtime is decreased, and the accuracy is decreased. As the length Lu1 of each mesh unit 376 is decreased, the partitioning resolution of the Mt conductive pattern 370 along the length direction (X axis) is increased, the runtime is increased, and the accuracy is increased. In at least one embodiment, when a higher accuracy of the thermal analysis is required along a particular direction, e.g., the length direction, the corresponding dimension, e.g., the length, of each mesh unit is decreased, without changing the other dimensions, e.g., the width and thickness, of the mesh unit. In some embodiments, at least one of the modeling rules applied in operations 307, 309, 311, or the like, of the thermal analysis 300A is predetermined in advance to provide a predetermined and intended balance between runtime and accuracy. In at least one embodiment, one or more modeling rules of the thermal analysis 300A are predetermined based on previous thermal analyses, e.g., through machine learning. In at least one embodiment, one or more modeling rules of the thermal analysis 300A are modifiable or enterable on site, e.g., by a circuit designer overseeing the thermal analysis 300A. An example for entering or modifying a modeling rule on site is to improve accuracy when there is still room for accuracy improvement under a current runtime requirement.

The metal layer M0 has a thickness TO that satisfies a third condition (e.g., second thickness threshold≥T0), and a corresponding third modeling rule is applied to model the metal layer M0. In some embodiments, the metal layer M0 is modeled in the same modeling approach as the top metal layer Mt and middle metal layer Mm, i.e., the metal layer M0 is partitioned into meshes, but at a partitioning resolution and/or mesh unit size different from those of the top metal layer Mt and middle metal layer Mm. For example, the M0 conductive pattern 350 is partitioned (not shown) along the length direction (X axis), but not along the width direction (Y axis) and thickness direction (Z axis).

In some embodiments, the metal layer M0 is modeled in accordance with a modeling approach different from that of the top metal layer Mt and middle metal layer Mm. For example, the overall thermal conductivity of the metal layer M0 is calculated based on a metal density of the metal layer M0. In at least one embodiment, the metal density of the metal layer M0 is determined from the data of the IC layout. The overall thermal conductivity of the metal layer M0 is calculated by multiplying the metal density of the metal layer M0 with the thermal conductivity of the metal material of the metal layer M0 (e.g., about 400 Wm-1K-1 where the metal material of the metal layer M0 is copper). In this modeling approach, various parameters of the metal layer M0, e.g., a width and a length of an M0 conductive pattern, a metal pitch of the metal layer M0, are not considered. The calculation is simpler compared to modeling with meshes, and the runtime is short. Although the accuracy is reduced in this approach compared to modeling with meshes, such reduced accuracy is acceptable for lower metal layers, such as the metal layer M0, in accordance with some embodiments. In one or more embodiments described herein, the other metal layers, i.e., the top metal layer Mt and the middle metal layer Mm, are modeled without using corresponding metal densities of the top metal layer Mt and middle metal layer Mm.

Although the modeling rules in accordance with some embodiments are described herein with respect to metal layers, similar modeling rules are applicable to model via layers. For example, thicker via layers at an upper part of the redistribution structure, are partitioned into meshes at various partitioning resolutions and/or different mesh unit sizes, whereas thinner via layers at a lower part of the redistribution structure are modeled in a simpler manner, e.g., by using metal densities of the thinner via layers. In some embodiments, the same modeling rule is applicable to both a metal layer and a via layer, provided that a property, e.g., the thickness, of the metal layer and the via layer satisfies a corresponding condition.

Returning to FIG. 3A, upon determining at operation 312 that all conductive layers of the redistribution structure have been considered and modeled in accordance with corresponding modeling rules (No from operation 312), the process proceeds to operation 314 where the processor is configured to assemble individual models of the conductive layers into a model of the redistribution structure. For example, as described with respect to operations 306-311 and FIG. 3B, the mesh of mesh units 376 into which the Mt conductive pattern 370 is partitioned is the model of the Mt conductive pattern 370, and the mesh of mesh units 366 into which the Mm conductive pattern 360 is partitioned is the model of the middle metal layer Mm. Models of other conductive patterns in the top metal layer Mt and middle metal layer Mm are generated in manners correspondingly similar to the Mt conductive pattern 370 and the Mm conductive pattern 360. Models of conductive patterns and vias in various metal layers and via layers schematically represented by vias 346, 347 are generated in similar manners. A model of the M0 conductive pattern 350, including the M0 conductive pattern 350 and other M0 conductive patterns, is generated based on a metal density of the metal layer M0. The generated models of the conductive layers are assembled into a model for the redistribution structure.

At operation 316, the processor is configured to, based on connectivity of a plurality of off-chip interconnects of the redistribution structure with external circuitry, assign different boundary conditions to the plurality of off-chip interconnects. In some embodiments, the processor is configured to assign further boundary conditions, e.g., to a substrate and/or a top surface of the top metal layer Mt, as described with respect to FIG. 2B. Other boundary conditions and/or interfaces assigned with such other boundary conditions are within the scopes of various embodiments.

FIG. 3C is a schematic perspective view of a portion of the IC device 300B with example boundary conditions assigned in the thermal analysis 300A, in accordance with some embodiments. For simplicity, components of the IC device 300B below the top metal layer Mt are omitted in FIG. 3C.

Compared with FIG. 3B, FIG. 3C further shows off-chip interconnects 382, 384 correspondingly over, and in electrical contact with, Mt conductive patterns 377, 378 of the top metal layer Mt. The off-chip interconnect 380 is configured to be electrically coupled, through the bump 381, to a conductive line 390 of external circuitry. In the example configuration in FIG. 3C, the conductive line 390 is a signal line having a narrow width and/or a short length, and configured to carry signals to be input into or output from the IC device 300B. An arrow 391 schematically shows a heat dissipation path through the off-chip interconnect 380 to the signal line 390. In some embodiments, signal lines are capable of transferring/dissipating low amounts of heat due to their narrow width and/or short length, and limited air cooling possibility.

The off-chip interconnect 382 is configured to be electrically coupled, through a corresponding bump 383, to a conductive line 392 of the external circuitry. In the example configuration in FIG. 3C, the conductive line 392 is a ground voltage line configured to provide a ground voltage (VSS) to the IC device 300B during operation. The ground voltage line 392 has a larger size, e.g., greater width and length, than signal lines, such as the signal line 390. In some embodiments, the ground voltage line 392 comprises a ground plane on a circuit board. In at least one embodiment, the larger size of the ground voltage line 392 permits a larger amount of heat to be dissipated therefrom than signal lines. Arrows 393 schematically show heat dissipation paths through the off-chip interconnect 382 to the ground voltage line 392.

The off-chip interconnect 384 is configured to be electrically coupled, through a corresponding bump 385, to a conductive line 394 of the external circuitry. In the example configuration in FIG. 3C, the conductive line 392 is a power supply voltage line configured to provide a power supply voltage (VDD) to the IC device 300B during operation. The power supply voltage line 394 has a larger size, e.g., greater width and length, than signal lines, such as the signal line 390. In at least one embodiment, the larger size of the power supply voltage line 394 permits a larger amount of heat to be dissipated therefrom than signal lines. However, the power supply voltage line 394 has a smaller size, e.g., smaller width and length, than the ground voltage line 392, and is capable of dissipate a smaller amount of heat than the ground voltage line 392.

Due to the different dimensions of the ground voltage line 392, power supply voltage line 394 and signal line 390, it is easier for heat generated by circuit devices of the IC device 300B during operation to dissipate through the off-chip interconnect 382 and ground voltage line 392, than through the off-chip interconnect 384 and power supply voltage line 394, and than through the off-chip interconnect 380 and signal line 390. To reflect this relationship in the thermal analysis 300A, a higher boundary condition corresponding to higher heat dissipation capability associated with the ground voltage line 392 is assigned to the off-chip interconnect 382, a medium boundary condition corresponding to a medium heat dissipation capability associated with the power supply voltage line 394 is assigned to the off-chip interconnect 384, and a lower boundary condition corresponding to lower heat dissipation capability associated with the signal line 390 is assigned to the off-chip interconnect 380. In some embodiments, boundary conditions are assigned as numeric values having the unit of W/cm2.

In some embodiments, the processor is configured to determine connectivity of each off-chip interconnect in the IC layout, e.g., based on an IC schematic input at operation 302. Based on the determined connectivity, the processor is further configured to assign lower boundary conditions to off-chip interconnects configured to be electrically coupled to signal lines, assign higher boundary conditions to off-chip interconnects configured to be electrically coupled to power supply voltage lines, and assign even higher boundary conditions to off-chip interconnects configured to be electrically coupled to ground voltage lines. Because the heat dissipation capabilities of the off-chip interconnects are realistically reflected by assigning corresponding, different boundary conditions to the off-chip interconnects, the accuracy of the thermal analysis is improved in one or more embodiments. In some embodiments, values of boundary conditions to be assigned are predetermined, for example, from libraries and/or previous thermal analyses. In at least one embodiment, at least one value of boundary condition is entered on site, e.g., by a circuit designer overseeing the thermal analysis 300A.

In some embodiments, in addition to or in lieu of boundary condition assignment based on connectivity, the processor is configured to assign boundary conditions based on a ratio of a current flowing through a BEOL net during operation to an area of the BEOL net. For example, for the off-chip interconnect 384, a ratio of a current I flowing therethrough during operation to an area of the VDD rail 394 electrically coupled to the off-chip interconnect 384 is determined and considered in boundary condition assignment. Such a ratio reflects a heating power during operation, where the current I for supplying power to operate the IC device 300B is large and potentially causes significant heating of the Mt conductive pattern 378 and the off-chip interconnect 384. The heating power caused by the current I potentially and/or significantly reduces the heat dissipation capability of the off-chip interconnect 384. In some embodiments, the described current to area ratio is negligible for signal pins electrically coupled to signal lines, because currents flowing through signal lines are too small to cause significant heating. In at least one embodiment, the described current-to-area ratio is negligible for ground pins, because the area of a ground voltage line, e.g., ground voltage line 392, is so large that the heat dissipation capability associated with the ground voltage line outweighs heating of the ground pin during operation. In some embodiments, when the heating power caused by a current during operation is considered through the described current-to-area ratio, the heat dissipation capability of the off-chip interconnect 384 is reduced. When the reduced heat dissipation capability of the off-chip interconnect 384 is still higher than the heat dissipation capability of the signal line 390, the off-chip interconnect 384 is assigned a boundary condition higher than the off-chip interconnect 380. When the reduced heat dissipation capability of the off-chip interconnect 384 becomes lower than the heat dissipation capability of the signal line 390, the off-chip interconnect 384 is assigned a boundary condition lower than the off-chip interconnect 380. In some embodiments, depending on the types of bumps and/or BEOL layers, different boundary conditions are assigned. For example, a higher boundary condition is assigned to a first off-chip interconnect configured to receive a bump of a first type with a higher heat dissipation capability, whereas a lower boundary condition is assigned to a second off-chip interconnect configured to receive a bump of a second type different from the first type and having a lower heat dissipation capability.

FIG. 3D is a schematic plan view of a portion of the IC device 300B with various boundary conditions assigned in the thermal analysis 300A, in accordance with some embodiments.

In the plan view in FIG. 3D, the IC device 300B comprises a plurality of off-chip interconnects 380, which are signal pins, and are arranged in a signal pin region 395. The IC device 300B further comprises a plurality of off-chip interconnects 382 which are ground pins, and a plurality of off-chip interconnects 384 which are power supply pins. The ground pins 382 and power supply pins 384 are arranged in a power-ground pin region 396. The ground pins 382 and power supply pins 384 are arranged alternatingly along both the X axis and the Y axis. In some embodiments, the signal pin region 395 occupies a central region of the IC device 300B, and the power-ground pin region 396 extends, e.g., in a ring shape, around the signal pin region 395. In at least one embodiment, the processor is configured to assign boundary conditions to the pins 380, 382, 384 of the IC device 300B based on connectivity. In such assignment, the ground pins 382 are assigned one or more higher boundary conditions, the power supply pins 384 are assigned one or more medium boundary conditions, and the signal pins 380 are assigned one or more lower boundary conditions. In some embodiments, the processor is configured to assign boundary conditions to the pins 380, 382, 384 of the IC device 300B based on a current-to-area ratio as described herein. Such assignment is schematically illustrated for a portion 397 of the IC device 300B, in which a ground pin 382 is assigned one or more higher boundary conditions corresponding to higher heat dissipation capability (High Cap. in FIG. 3D), power supply pins 384 are assigned one or more lower boundary conditions corresponding to lower heat dissipation capability (Low Cap. in FIG. 3D), and signal pins 380 are assigned one or more medium boundary conditions corresponding to medium heat dissipation capability (Medium Cap. in FIG. 3D). The described three levels of boundary conditions are examples. In some embodiments, two, or more than two, different boundary conditions are assigned to the off-chip interconnects of the IC device 300B.

Returning to FIG. 3A, upon completing operation 316 in which different boundary conditions are assigned to different off-chip interconnects, as well as other thermal interfaces for dissipating heat to the external environment, such as, a top surface of the top metal layer Mt, the substrate, or the like, the process proceed to operation 318 where a thermal simulation for the IC layout is performed. The thermal simulation is performed based on the models of the conductive layers obtained by applying different modeling rules in operations 306-312, and the different boundary conditions assigned at operation 316. Example thermal simulations include, but are not limited to, finite element, finite volume, finite difference, Monte Carlo, or the like. Upon completion of the thermal simulation, a result of the thermal simulation, e.g., a heat distribution, or a temperature map, is output as a result of the thermal analysis 300A. Based on the result of the thermal analysis 300A, the IC layout is modified as described with respect to operation 108, or is output for manufacturing as described with respect to operation 110.

Various features in the described thermal analysis 300A are examples. For example, although the thermal analysis 300A in FIG. 3A includes, in the loop between operations 304, 312, at least three conditions and at least three corresponding modeling rules, it is within the scope of one or more embodiments to consider two conditions and apply two corresponding modeling rules, i.e., operations 310, 311 are omitted. For another example, although operation 316 in FIG. 3A is described as assigning different boundary conditions to different off-chip interconnects, it is within the scope of one or more embodiments to assign the same boundary condition to all off-chip interconnects. In such one or more embodiments, one or more advantages described herein are still achievable by applying different modeling rules to conductive layers, based on different conditions being satisfied by a property of the conductive layers, as described with respect to one or more operations in the loop between operations 304, 312. For a further example, it is within the scope of one or more embodiments to omit operations 304-312, i.e., the conductive layers are modeled in the same manner, resolution and mesh unit size. In such one or more embodiments, one or more advantages described herein are still achievable by assigning different boundary conditions to different off-chip interconnects, as described with respect to operation 316.

In a thermal analysis in accordance with some embodiments, a balance between accuracy and processing time (e.g., runtime) is achievable. This is an improvement over other approaches. A first, other approach includes a density-based thermal simulation with full-chip simulation capability and short runtime, but with low accuracy in various situations. In the first, other approach, various aspects such as routing width, pitch, length, connectivity are not considered, despite that the width, pitch and thickness from the bottom metal layer (M0) to the topmost metal layer (Mt) vary more than 20 times in various situations. Failing to consider such aspects contributes to low accuracy of the first, other approach. In contrast, various aspects such as routing width, pitch, length, connectivity are considered in a thermal simulation in accordance with some embodiments. In at least one embodiment, thicker metal layers capable of transferring a large amount of heat are modeled in greater detail or resolution than thinner metal layers, to improve accuracy. The thinner metal layers are modeled with lower resolution, to improve runtime and/or processing (computation) requirements. In at least one embodiment, it is possible to improve accuracy from ±75% error in accordance with the first, other approach to be within ±10% error, at an acceptable increase of runtime by about 10 times.

A second, other approach uses fine meshes for all conductive layers to achieve high accuracy, but with significantly increased runtime in various situations. In some situations, the long runtime and/or high computation requirements do not permit a full-chip thermal simulation. In contrast, a thermal analysis in accordance with some embodiments uses various modeling rules with different resolutions for modeling the conductive layers to achieve a balance between accuracy and runtime. In at least one embodiment, a complete thermal simulation of an entire chip is possible at acceptable runtime, with accuracy essentially as high as the accuracy of the second, other approach.

Further, instead of a fixed/same boundary condition assigned to all thermal interfaces of an IC device as in other approaches, the thermal analysis in accordance with some embodiments assigns different boundary conditions to different off-chip interconnects, based on connectivity and/or current-to-area ratio at each off-chip interconnect, to explicitly model the heat transfer rate due to connection of each off-chip interconnect to external cooling or heat dissipation features. As a result, cooling or heat dissipation capability of external circuitry and/or external environment are taken into account, thereby further improving accuracy of the thermal simulation. Other effects and/or advantages are within the scopes of various embodiments, as described herein.

FIG. 4 is a flowchart of a thermal analysis 400, in accordance with some embodiments. In some embodiments, the thermal analysis 400 corresponds to one or more of the thermal analyses 150, 300A, and/or is performed at least in part by at least one processor as described herein. The thermal analysis 400 comprises operations 406-411 corresponding to operations 306-311 of the thermal analysis 300A. Other corresponding components of the thermal analyses 300A, 400 are designated by the same reference numerals.

The thermal analysis 400 is an example thermal analysis which uses a thickness of each conductive layer in a redistribution structure of an IC layout to determine how the conductive layer is to be modeled in the thermal analysis.

Specifically, at operation 406, the processor is configured to determine whether the thickness (along the Z axis) of the current conductive layer satisfies a first condition that the thickness is greater than or equal to a predetermined thickness threshold of nT0 (Thickness≥nT0), where n is a natural number, and TO is the thickness of the thinnest conductive layer (the metal layer M0) of the redistribution structure.

In response to a positive determination (Yes) from operation 406, the current conductive layer is considered as a thick conductive layer, and the process proceeds to operation 407 where the processor is configured to apply a corresponding modeling rule for thick conductive layers to the current conductive layer. In some embodiments, the modeling rule for thick conductive layers at operation 407 corresponds to the first modeling rule at operation 307, and results in the current conductive layer being modeled in a manner similar to the Mt conductive pattern 370 in FIG. 3B. For example, thick conductive layers are partitioned in all width, length and thickness directions. In other words, fine-grain partitioning is applied to thick conductive layers.

In response to a negative determination (No) from operation 406, the process proceeds to operation 408 where the processor is configured to determine whether the thickness of the current conductive layer satisfies a second condition that the thickness is smaller than nT0 but is greater than or equal to another predetermined thickness threshold of mT0 (nT0>Thickness≥mT0), where m is a natural number smaller than n.

In response to a positive determination (Yes) from operation 408, the current conductive layer is considered as a medium conductive layer, and the process proceeds to operation 409 where the processor is configured to apply a corresponding modeling rule for medium conductive layers to the current conductive layer. In some embodiments, the modeling rule for medium conductive layers at operation 409 corresponds to the second modeling rule at operation 309, and results in the current conductive layer being modeled in a manner similar to the Mm conductive pattern 360 in FIG. 3B. For example, medium conductive layers are partitioned in the width and length directions, but not in the thickness direction. In other words, coarse-grain partitioning is applied to medium conductive layers.

In response to a negative determination (No) from operation 408, i.e., the thickness of the current conductive layer is smaller than mT0 (mT0>Thickness), the current conductive layer is considered as a thin conductive layer, and the process proceeds to operation 411 where the processor is configured to apply a corresponding modeling rule for thin conductive layers to the current conductive layer. In some embodiments, the modeling rule for thin conductive layers at operation 411 corresponds to the third modeling rule at operation 311, and results in the current conductive layer being modeled in a manner similar to the M0 conductive pattern 350 in FIG. 3B. For example, each thin conductive layer is modeled by the corresponding overall thermal conductivity calculated based on a metal density of the thin conductive layer. In at least one embodiment, other aspects and/or operations in the thermal analysis 400 are similar to corresponding aspects and/or operations in the thermal analysis 300A.

The described definitions of thick, medium and thin conductive layers based on multiples (i.e., n and m) of the thickness of the thinnest conductive layer is an example. Other configurations are within the scopes of various embodiments. For example, in at least one of operations 406, 408, the thickness of the current conductive layer is compared with a specific thickness value (e.g., in micron or nanometer). The described division of the conductive layers of the redistribution structure into three groups (i.e., thick, medium and thin conductive layers) is also an example. It is within the scopes of various embodiments to divide the conductive layers of the redistribution structure into two, or more than three, groups. In at least one embodiment, one or more advantages described herein are achievable by the thermal analysis 400.

FIG. 5A is a flowchart of a thermal analysis 500A, in accordance with some embodiments. In some embodiments, the thermal analysis 500A corresponds to one or more of the thermal analyses 150, 300A, 400 and/or is performed at least in part by at least one processor as described herein. Corresponding components of the thermal analyses 300A, 500A are designated by the same reference numerals.

The thermal analysis 500A is an example thermal analysis which uses two properties for dividing the conductive layers of a redistribution structure in an IC layout into groups each subject to a different modeling rule. Specifically, the thermal analysis 500A uses the thickness and width of each conductive layer to determine how the conductive layer is to be modeled in the thermal analysis. It is within the scope various embodiments to use thickness and a property other than width, or use width and a property other than thickness, or use two properties other than thickness and width, for dividing the conductive layers into groups. It is also within the scope various embodiments to use more than two properties for dividing the conductive layers into groups.

Specifically, at operation 506, the processor is configured to determine whether the thickness (along the Z axis) of the current conductive layer satisfies a first condition that the thickness is greater than or equal to a predetermined thickness threshold of kT0 (Thickness≥kT0), where k is a natural number. In an example embodiment, k is 5. Other values of k are within the scopes of various embodiments.

In response to a positive determination (Yes) from operation 506, the current conductive layer is considered as a thick conductive layer, and the process proceeds to operation 520 where the processor is configured to determine whether the width of conductive patterns in the current conductive layer satisfies a second condition that the width is greater than a predetermined width threshold of jW0 (Width>jW0), where j is a natural number, and W0 is the width conductive patterns in the metal layer M0. In an example embodiment, j is 5. Other values of j are within the scopes of various embodiments.

In response to a positive determination (Yes) from operation 520, the current conductive layer is considered as a thick and wide conductive layer, and the process proceeds to operation 507 where the processor is configured to apply a corresponding modeling rule for thick and wide conductive layers to the current conductive layer. In the example configuration in FIG. 5A, the modeling rule at operation 507 is that thick and wide conductive layers are partitioned with fine-grain partitioning in all width, length and thickness directions. In other words, fine-grain partitioning along the X axis, Y axis and Z axis is applied to thick and wide conductive layers. In at least one embodiment, fine-grain partitioning in all width, length and thickness directions improves accuracy of modeling and/or simulating thick and wide conductive layers.

In response to a negative determination (No) from operation 520, the current conductive layer is considered as a thick and narrow conductive layer, and the process proceeds to operation 509 where the processor is configured to apply a corresponding modeling rule for thick and narrow conductive layers to the current conductive layer. In the example configuration in FIG. 5A, the modeling rule at operation 509 is that thick and narrow conductive layers are partitioned with coarse-grain partitioning in the width direction and/or length directions, and with fine-grain partitioning in the thickness direction. In other words, coarse-grain partitioning along the X axis and/or Y axis, and fine-grain partitioning along the Z axis are applied to thick and narrow conductive layers. In at least one embodiment, coarse-grain partitioning in the width direction and/or length direction reduces the amount of computation and shortens runtime, whereas fine-grain partitioning in the thickness direction ensures sufficient accuracy of modeling and/or simulating thick and narrow conductive layers.

In response to a negative determination (No) from operation 506, i.e., the thickness of the current conductive layer is smaller than kT0 (kT0>Thickness), the current conductive layer is considered as a thin conductive layer, and the process proceeds to operation 522 where the processor is configured to determine whether the width of conductive patterns in the current conductive layer satisfies a third condition that the width is greater than a predetermined width threshold of iW0 (Width>iW0), where i is a natural number. In at least one embodiment, i=j. In some embodiments, i is different from j. For example, i<j.

In response to a positive determination (Yes) from operation 522, the current conductive layer is considered as a thin and wide conductive layer, and the process proceeds to operation 511 where the processor is configured to apply a corresponding modeling rule for thin and wide conductive layers to the current conductive layer. In the example configuration in FIG. 5A, the modeling rule at operation 511 is that thin and wide conductive layers are partitioned in the width and length directions, without being partitioned in the thickness direction. In other words, partitioning only along the X axis and Y axis is applied to thin and wide conductive layers. In at least one embodiment, this modeling rule reduces the amount of computation and shortens runtime, while ensuring sufficient accuracy of modeling and/or simulating thin and wide conductive layers.

In response to a negative determination (No) from operation 522, the current conductive layer is considered as a thin and narrow conductive layer, and the process proceeds to operation 513 where the processor is configured to apply a corresponding modeling rule for thin and narrow conductive layers to the current conductive layer. In the example configuration in FIG. 5A, the modeling rule at operation 513 is that each thin and narrow conductive layer is modeled by the corresponding overall thermal conductivity calculated based on a metal density of the thin and narrow conductive layer. In at least one embodiment, this modeling rule reduces the amount of computation and shortens runtime of modeling and/or simulating thin and narrow conductive layers. In at least one embodiment, other aspects and/or operations in the thermal analysis 500A are similar to corresponding aspects and/or operations in the thermal analysis 300A.

The described definitions of thick and wide, thick and narrow, thin and wide, and thin and narrow conductive layers based on multiples (i.e., k, j, i) of the thickness or width of the metal layer M0 is an example. Other configurations are within the scopes of various embodiments. For example, in at least one of operations 506, 520, 522, the thickness or width of the current conductive layer is compared with a specific thickness or width value (e.g., in micron or nanometer). In some embodiments, a thermal analysis that uses multiple properties for dividing conductive layers into groups with corresponding modeling rules makes it possible to provide more specific modeling for various BEOL shapes in the conductive layers. In at least one embodiment, one or more advantages described herein are achievable by the thermal analysis 500A.

FIG. 5B is a schematic perspective view of a portion of an IC device 500B modeled in the thermal analysis 500A, in accordance with some embodiments. In some embodiments, the IC device 500B corresponds to one or more of the IC devices 200B, 300B. For simplicity, corresponding components of the IC devices 300B, 500B are designated by the same reference numerals.

The IC device 500B comprises a conductive pattern 570 which is an example of a conductive pattern in a thick and wide conductive layer. The conductive pattern 570 is subject to the corresponding modeling rule described with respect to operation 507. Specifically, the conductive pattern 570 is partitioned with fine-grain partitioning in all of the width direction (Y axis), length direction (X axis) and thickness direction (Z axis), in a manner similar to that described with respect to the Mt conductive pattern 370.

The IC device 500B further comprises a conductive pattern 565B which is an example of a conductive pattern in a thick and narrow conductive layer. The conductive pattern 565B is subject to the corresponding modeling rule described with respect to operation 509. Specifically, the conductive pattern 565B is partitioned with coarse-grain partitioning in the length direction (Y axis), no partitioning in the width direction (X axis), and fine-grain partitioning in the thickness direction (Z axis). In the example configuration in FIG. 5B, the conductive pattern 565B in a metal layer below the conductive pattern 570 is partitioned in the thickness direction at a resolution (three layers 564 of mesh units 566) higher than the conductive pattern 570 (with two layers 574 of mesh units).

The IC device 500B further comprises a conductive pattern 560 which is an example of a conductive pattern in a thin and wide conductive layer. The conductive pattern 560 is subject to the corresponding modeling rule described with respect to operation 511. Specifically, the conductive pattern 560 is partitioned in the width direction (Y axis) and the length direction (X axis), with no partitioning in the thickness direction (Z axis). In some embodiments, the conductive pattern 560 is partitioned in a manner similar to that described with respect to the Mm conductive pattern 360.

The IC device 500B further comprises a conductive pattern 550 which is an example of a conductive pattern in a thin and narrow conductive layer. The conductive pattern 550 is subject to the corresponding modeling rule described with respect to operation 513. Specifically, the conductive pattern 550 is modeled by the corresponding overall thermal conductivity calculated based on a metal density of the thin and narrow conductive layer containing the conductive pattern 550, in a manner similar to that described with respect to the M0 conductive pattern 350. In at least one embodiment, one or more advantages described herein are achievable by a thermal analysis using models of conductive layers as described with respect to the IC device 500B.

FIG. 5C is a schematic perspective view of a portion of an IC device 500C modeled in a thermal analysis, in accordance with some embodiments. In some embodiments, the IC device 500C corresponds to one or more of the IC devices 200B, 300B, 500B. For simplicity, corresponding components of the IC devices 300B, 500B, 500C are designated by the same reference numerals.

Compared with the IC device 500B in which the conductive pattern 565B is partitioned with no partitioning in the width direction (X axis) and coarse-grain partitioning in the length direction (Y axis), a conductive pattern 565C in the IC device 500C is partitioned with coarse-grain partitioning or fine-grain partitioning in the width direction (X axis) and with fine-grain partitioning in the length direction (Y axis). The partitioning resolution of the conductive pattern 565C in the thickness direction (Z axis) is the same as the conductive pattern 565B. Due to the change in the partitioning approach, mesh units 567 of the conductive pattern 565C in the IC device 500C has a smaller mesh unit size than mesh units 566 of the conductive pattern 565B in the IC device 500B. In at least one embodiment, the IC device 500C provides improvement in the accuracy of modeling and/or simulating the conductive pattern 565C, compared to the IC device 500B.

In some embodiments, the partitioning approaches described with respect to the conductive patterns 565B, 565C are applicable to various metal layers in an IC device. For example, the IC device comprises one or more lower metal layers, one or more lower middle metal layers over the one or more lower metal layers, one or more upper middle metal layers over the one or more lower middle metal layers, and one or more upper metal layers over the one or more upper middle metal layer. The one or more lower metal layers are partitioned similarly to the conductive pattern 550 and/or the conductive pattern 560. The one or more lower middle metal layers are partitioned similarly to the conductive pattern 565B in FIG. 5B. The one or more upper middle metal layers are partitioned similarly to the conductive pattern 565C in FIG. 5C. The one or more upper metal layers are partitioned similarly to the conductive pattern 570.

The width of conductive patterns in the one or more lower middle metal layers are relatively narrow, and permits the one or more lower middle metal layers to be partitioned similarly to the conductive pattern 565B with no partitioning in the width direction, based on an assumption that heat transfer is uniform across the width of the conductive patterns. In at least one embodiment, such a partitioning approach makes it possible to reduce processing time (e.g., runtime), without significantly affecting accuracy of the thermal simulation. However, the widths of conductive patterns are increased at higher metal layers, and the assumption that heat transfer is uniform across the width of the conductive patterns is likely to lead to inaccuracy of the thermal simulation at higher metal layers. Therefore, the one or more upper middle metal layers, in which the width of conductive patterns is wider than in the one or more lower middle metal layers, are partitioned similarly to the conductive pattern 565C with partitioning in the width direction. In at least one embodiment, such a partitioning approach makes it possible to increase accuracy of the thermal simulation at the one or more upper middle metal layers.

In some embodiments, a local partitioning definition is assigned or applied to a conductive layer, or a group of conductive layers, among a plurality of conductive layers to be partitioned for a thermal simulation. In at least one embodiment, a global partitioning definition is assigned or applied to all conductive layers to be partitioned for a thermal simulation. In some embodiments, a partitioning definition comprises one or more parameters, such as, a width of a mesh unit, a length of the mesh unit, a thickness of the mesh unit, a partitioning style, or the like.

In some embodiments, a local partitioning definition is layer dependent. For example, metal layers M0, M1, M2 are considered as a first local group to which a first local partitioning definition is applied, and metal layers M0, M1, M2 are partitioned in the same manner, e.g., with the same mesh unit size and partitioning style. Metal layers M3, M4, M5 are considered as a second local group to which a second local partitioning definition is applied, and metal layers M3, M4, M5 are partitioned in the same manner, e.g., with the same mesh unit size and partitioning style. The first local partitioning definition of metal layers M0, M1, M2 differs from the second local partitioning definition of metal layers M3, M4, M5 in the mesh unit size and/or partitioning style. In at least one embodiment, each conductive layer has a corresponding local partitioning definition with at least one parameter different from local partitioning definitions of other conductive layers.

In some embodiments, a global partitioning definition comprises at least one parameter that is applied to all conductive layers to be partitioned. In at least one embodiment, a global partitioning definition is applied to all metal layers to be partitioned, such that all of the metal layers are partitioned in the same manner, e.g., with the same mesh unit size and partitioning style.

In some embodiments, in the width direction and/or the length direction, a global partitioning definition is assigned to all metal layers to be partitioned, whereas in the thickness direction, each metal layer or each group of metal layers is assigned with a corresponding local partitioning definition. For example, the global partitioning definition is applied such that the mesh units of all metal layers to be partitioned have the same width and/or the same length, whereas the thicknesses of the mesh units of the metal layers vary in accordance with the corresponding local partitioning definitions.

FIG. 6A is a flowchart of a thermal analysis 600A, in accordance with some embodiments. In some embodiments, the thermal analysis 600A corresponds to one or more of the thermal analyses 150, 300A, 400, 500A and/or is performed at least in part by at least one processor as described herein. Corresponding components of the thermal analyses 300A, 600A are designated by the same reference numerals.

Compared with the thermal analysis 300A which includes different modeling rules corresponding to different groups of conductive layers satisfying different conditions, the thermal analysis 600A includes just one modeling rule applicable to all conductive layers in a redistribution structure.

Specifically, at operation 620, the processor is configured to partition each conductive layer with the same mesh unit size having mesh dimensions mesh_x, mesh_y, mesh_z correspondingly along the X axis, Y axis, Z axis. In at least one embodiment, other aspects and/or operations in the thermal analysis 600A are similar to corresponding aspects and/or operations in the thermal analysis 300A. In at least one embodiment, one or more advantages described herein are achievable by the thermal analysis 600A. For example, in one or more embodiments, using the same mesh unit size for all conductive layers simplifies the modeling at operation 620 which contributes to improved (i.e., shorten) runtime of the thermal analysis. In at least one embodiment, the accuracy of the thermal analysis is improved at least thanks to the different boundary conditions assigned to different off-chip interconnects at operation 316.

FIG. 6B is a schematic perspective view of a portion of an IC device 600B modeled in the thermal analysis 600A, in accordance with some embodiments. In some embodiments, the IC device 600B corresponds to one or more of the IC devices 200B, 300B, 500B, 500C. For simplicity, corresponding components of the IC devices 300B, 600B are designated by the same reference numerals.

In the IC device 600B, each conductive layer is partitioned into a plurality of mesh units 666 having the mesh unit size described with respect to operation 620 in FIG. 6A. In some embodiments, when a conductive layer has a dimension smaller than a corresponding mesh dimension, the mesh dimension is ignored. For example, in situations where the width W0 (along Y axis) of the M0 conductive pattern 350 is smaller than the corresponding mesh dimension mesh_y, the mesh dimension mesh_y is ignored, and the mesh units 666 in the model of the M0 conductive pattern 350 have a dimension W0 (instead of the mesh dimension mesh_y) along the Y axis. In at least one embodiment, one or more advantages described herein are achievable by a thermal analysis using models of conductive layers as described with respect to the IC device 600B.

FIG. 7A is a flowchart of a thermal analysis 700, in accordance with some embodiments. In some embodiments, the thermal analysis 700 corresponds to one or more of the thermal analyses 150, 300A, 400, 500A, 600A and/or is performed at least in part by at least one processor as described herein. Corresponding components of the thermal analyses 300A, 700 are designated by the same reference numerals.

Compared with the thermal analysis 300A which uses a property of a current conductive layer to determine how the conductive layer is to be modeled, the thermal analysis 700 uses an index or a position of the current conductive layer in the redistribution structure to find a pre-defined mesh unit size to be applied for partitioning the conductive layer.

Specifically, at operation 720, for each conductive layer, the processor is configured to access a mesh unit size table 722 to find a pre-defined mesh unit size corresponding to the conductive layer. An example of the mesh unit size table 722 is illustrated in FIG. 7B. The mesh unit size table 722 includes, for each conductive layer, corresponding mesh dimensions of a mesh unit with which the conductive layer is to be partitioned. For example, a metal layer Mh (where h is an integer from zero and up) is to be partitioned into mesh units having a set of mesh dimensions mₕ_mesh_x, mₕ_mesh_y, mₕ_mesh_z correspondingly along the X axis, Y axis, Z axis, another metal layer M (h+1) is to be partitioned into mesh units having another set of mesh dimensions mₕ₊₁_mesh_x, mₕ₊₁_mesh_y, mₕ₊₁_mesh_z correspondingly along the X axis, Y axis, Z axis, a further metal layer M (h+2) is to be partitioned into mesh units having a further set of mesh dimensions mₕ₊₂_mesh_x, mₕ₊₂_mesh_y, mₕ₊₂_mesh_z correspondingly along the X axis, Y axis, Z axis, or the like. In some embodiments, at least one mesh dimension for a conductive layer is different from a corresponding mesh dimension (along the same axis/direction) of another conductive layer. For example, mₕ_mesh_x is different from mₕ₊₂_mesh_x, mₕ₊₁_mesh_y is different from mₕ₊₂_mesh_y, or the like. In some embodiments, the mesh dimensions in the mesh unit size table 722 are predefined, e.g., from one or more libraries and/or previous thermal analyses. In at least one embodiment, the mesh unit size table 722 is stored on a non-transitory computer-readable storage medium.

At operation 724, upon retrieving the corresponding mesh dimensions for the current conductive layer from the mesh unit size table 722, the processor is configured to partition the current conductive layer into mesh units having the retrieved mesh dimensions. In some embodiments, an IC device modeled in accordance with the process described with respect to operations 720, 724 and mesh unit size table 722, is similar to the IC device 300B, with an exception that the M0 conductive pattern 350 is partitioned into mesh units similarly to FIG. 6B. In at least one embodiment, other aspects and/or operations in the thermal analysis 700 are similar to corresponding aspects and/or operations in the thermal analysis 300A. In at least one embodiment, one or more advantages described herein are achievable by the thermal analysis 700.

FIG. 8A is a flowchart of a thermal analysis 800A, in accordance with some embodiments. In some embodiments, the thermal analysis 800A corresponds to one or more of the thermal analyses 150, 300A, 400, 500A, 600A, 700 and/or is performed at least in part by at least one processor as described herein. Corresponding components of the thermal analyses 300A, 400, 800A are designated by the same reference numerals.

Similarly to the thermal analysis 400A, the thermal analysis 800A, at operations 406, 408, divides conductive layers by their thickness into thick conductive layers, medium conductive layers, and thin conductive layer. In some embodiments, n is 10 and m is 3 in operations 406, 408. Other values of n and/or m are within the scopes of various embodiments.

At operation 807, in response to determining that the current conductive layer is a thick conductive layer, the processor is configured to model the current conductive layer by applying uniform partitioning along the X axis and Y axis, and applying variable partitioning along the Z axis. An example of modeling at operation 807 is described with respect to the Mt conductive pattern 870 in FIG. 8B.

At operation 809, in response to determining that the current conductive layer is a medium conductive layer, the processor is configured to model the current conductive layer by applying uniform partitioning along the X axis and Y axis, without partitioning along the Z axis, in a manner similar to that described with respect to the middle metal layer Mm 360 in FIG. 3B.

At operation 811, in response to determining that the current conductive layer is a thin conductive layer, the processor is configured to model the current conductive layer by the corresponding overall thermal conductivity calculated based on a metal density of the current conductive layer, in a manner similar to that described with respect to the M0 conductive pattern 350 in FIG. 3B. In at least one embodiment, other aspects and/or operations in the thermal analysis 800A are similar to corresponding aspects and/or operations in the thermal analyses 300A, 400. In at least one embodiment, one or more advantages described herein are achievable by the thermal analysis 800A. In some embodiments, in addition to achieving a global balance between runtime and accuracy for the thermal analysis with respect to the whole redistribution structure, it is further possible to achieve a local balance between runtime and accuracy for the thermal analysis with respect to an individual conductive layer, thanks to variable partitioning applied to the conductive layer as described herein.

FIG. 8B is a schematic perspective view of a portion of an IC device 800B modeled in the thermal analysis 800A, in accordance with some embodiments. In some embodiments, the IC device 800B corresponds to one or more of the IC devices 200B, 300B, 500B, 500C, 600B. For simplicity, corresponding components of the IC devices 300B, 800B are designated by the same reference numerals.

In FIG. 8B, the Mt conductive pattern 870 is an example of how a conductive layer is modeled with variable partitioning along the Z axis, as described in operation 807. For example, the Mt conductive pattern 870 is partitioned along the Z axis to include a plurality of layers of mesh units of different mesh unit sizes, i.e., a layer 821 of mesh units 831, a layer 822 of mesh units 832 over the layer 821, a layer 823 of mesh units 833 over the layer 822, and a layer 824 of mesh units 834 over the layer 823. The layer 821 is arranged on a first side 871 of the Mt conductive pattern 870 which faces toward the circuit devices on the substrate 330. The layers 822, 823, 824 are increasingly farther from the circuit devices, with the layer 824 being arranged on a second side 872 of the Mt conductive pattern 870 which faces away from the circuit devices. As a result, the layer 821 is the closest to heat sources being the circuit devices in operation, and the layer 824 is the farthest from the heat sources.

The mesh units 831-834 have the same mesh dimensions along the X axis and Y axis, corresponding to the uniform partitioning described with respect to operation 807. Along the Z axis, the mesh units 831-834 have different mesh dimensions, corresponding to the variable partitioning described with respect to operation 807. Specifically, along the Z axis, the mesh units 831 and the corresponding layer 821 are the thinnest, the mesh units 832 and the corresponding layer 822 are thicker than the mesh units 831 and layer 821, the mesh units 833 and the corresponding layer 823 are thicker than the mesh units 832 and layer 822, and the mesh units 834 and the corresponding layer 824 are thicker than the mesh units 833 and layer 823. In some embodiments, the thickness of the layer 821 is/times smaller than the thickness of the layer 822, which is/times smaller than the thickness of the layer 823, which is I times smaller than the thickness of the layer 824. In at least one embodiment, l is 10. In an example configuration, the mesh dimensions of the mesh units 831-834 along the X axis and Y axis are 10 nm, and the mesh dimensions of the mesh units 831-834 along the Z axis correspondingly are 0.01 nm, 0.1 nm, 1 nm, 10 nm.

In the model of the Mt conductive pattern 870, the thinnest layer 821 is arranged closest to the heat sources, and the layers 822, 823, 824 are increasingly thicker and are arranged increasingly farther from the heat sources, with the thickest layer 824 being the farthest from the heat sources. In at least one embodiment, such variable partitioning improves a local accuracy of the thermal analysis at the Mt conductive pattern 870 because the partitioning resolution is the highest on the side 871 closest to the heat sources, and also improves local runtime of the thermal analysis at the Mt conductive pattern 870 because the partitioning resolution is increasingly reduced in a direction away from the heat sources.

In FIG. 8B, the Mm conductive pattern 360 and M0 conductive pattern 350 are examples of conductive layers modeled in corresponding operations 809, 811, and are similar to the Mm conductive pattern 360 and M0 conductive pattern 350 described with respect to FIG. 3B. In at least one embodiment, one or more advantages described herein are achievable by a thermal analysis using models of conductive layers as described with respect to the IC device 800B.

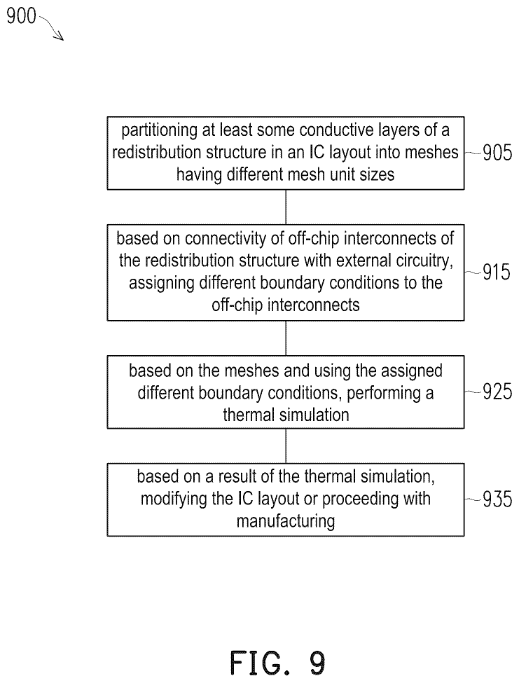

FIG. 9 is a flowchart of a method 900, in accordance with some embodiments. In some embodiments, the method 900 performs a thermal analysis corresponding to one or more of the thermal analyses 150, 300A, 400, 500A, 600A, 700, 800A and/or is performed at least in part by at least one processor as described herein.

At operation 905, based on at least one physical property of a plurality of conductive layers of a redistribution structure in an integrated circuit (IC) layout, at least some of the plurality of conductive layers are partitioned into a plurality of meshes having different mesh unit sizes. Examples of an integrated circuit (IC) layout having a redistribution structure with a plurality of conductive layers are described with respect to FIGS. 2A, 2B. At least some of the conductive layers are partitioned into meshes having different mesh unit sizes, e.g., as described with respect to FIG. 3B in which the Mt conductive pattern 370 is partitioned into a mesh of mesh units 376, and the Mm conductive pattern 360 is partitioned into a mesh of mesh units 366, and the mesh unit sizes of the mesh units 376, 366 are different from each other. In some embodiments, one or more conductive layers, e.g., the M0 conductive pattern 350, are not partitioned into a mesh, and are instead modeled based on their metal density, as described with respect to FIG. 3B. In at least one embodiment, all conductive layers are partitioned into meshes.

At operation 915, based on connectivity of a plurality of off-chip interconnects of the redistribution structure with external circuitry, different boundary conditions are assigned to the plurality of off-chip interconnects. Examples of off-chip interconnects of a redistribution structure are described with respect to FIGS. 2B, 3B-3D. Different boundary conditions are assigned to the off-chip interconnects based on their connectivity with the external circuitry, e.g., as described with respect to FIG. 3C. For example, off-chip interconnects to be coupled to larger conductive features, such as power rails of the external circuitry, are assigned higher boundary conditions, whereas off-chip interconnects to be coupled to smaller conductive features, such as signal lines of the external circuitry, are assigned lower boundary conditions. In some embodiments, a current-to-area ratio associated with an off-chip interconnect, e.g., a power supply pin, is considered to adjust its heat dissipation capability and corresponding boundary condition, as described with respect to FIGS. 3C-3D.

At operation 925, a thermal simulation for the IC layout is performed based on the plurality of meshes and using the different boundary conditions assigned to the plurality of off-chip interconnects, e.g., as described with respect to operation 318 in FIG. 3A.

At operation 935, based on a result of the thermal simulation, the IC layout is modified, or the process proceeds to manufacture one or more IC devices corresponding to the IC layout, e.g., as described with respect to operations 108, 110 in FIG. 1. In at least one embodiment, one or more advantages described herein are achievable by the method 900.

The described methods include example operations, but they are not necessarily required to be performed in the order shown. Operations may be added, replaced, changed order, and/or eliminated as appropriate, in accordance with the spirit and scope of embodiments of the disclosure. Embodiments that combine different features and/or different embodiments are within the scope of the disclosure and will be apparent to those of ordinary skill in the art after reviewing this disclosure.

In some embodiments, at least one method(s) discussed above is performed in whole or in part by at least one EDA system. In some embodiments, an EDA system is usable as part of a design house of an IC manufacturing system discussed below.

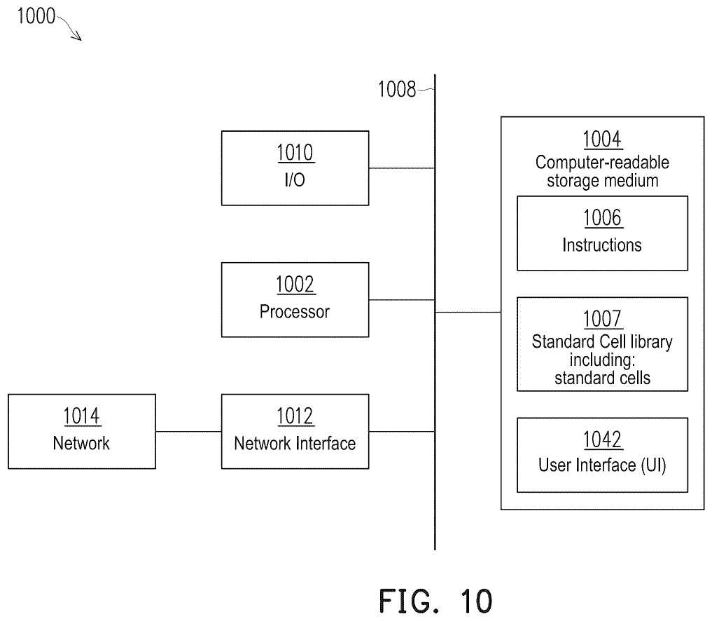

FIG. 10 is a block diagram of an electronic design automation (EDA) system 1000 in accordance with some embodiments.

In some embodiments, EDA system 1000 includes an APR system. Methods described herein of designing layout diagrams represent wire routing arrangements, in accordance with one or more embodiments, are implementable, for example, using EDA system 1000, in accordance with some embodiments.

In some embodiments, EDA system 1000 is a general purpose computing device including a hardware processor 1002 and a non-transitory, computer-readable storage medium 1004. Storage medium 1004, amongst other things, is encoded with, i.e., stores, computer program code 1006, i.e., a set of executable instructions. Execution of instructions 1006 by hardware processor 1002 represents (at least in part) an EDA tool which implements a portion or all of the methods described herein in accordance with one or more embodiments (hereinafter, the noted processes and/or methods).

Processor 1002 is electrically coupled to computer-readable storage medium 1004 via a bus 1008. Processor 1002 is also electrically coupled to an I/O interface 1010 by bus 1008. A network interface 1012 is also electrically connected to processor 1002 via bus 1008. Network interface 1012 is connected to a network 1014, so that processor 1002 and computer-readable storage medium 1004 are capable of connecting to external elements via network 1014. Processor 1002 is configured to execute computer program code 1006 encoded in computer-readable storage medium 1004 in order to cause system 1000 to be usable for performing a portion or all of the noted processes and/or methods. In one or more embodiments, processor 1002 is a central processing unit (CPU), a multi-processor, a distributed processing system, an application specific integrated circuit (ASIC), and/or a suitable processing unit.

In one or more embodiments, computer-readable storage medium 1004 is an electronic, magnetic, optical, electromagnetic, infrared, and/or a semiconductor system (or apparatus or device). For example, computer-readable storage medium 1004 includes a semiconductor or solid-state memory, a magnetic tape, a removable computer diskette, a random access memory (RAM), a read-only memory (ROM), a rigid magnetic disk, and/or an optical disk. In one or more embodiments using optical disks, computer-readable storage medium 1004 includes a compact disk-read only memory (CD-ROM), a compact disk-read/write (CD-R/W), and/or a digital video disc (DVD).

In one or more embodiments, storage medium 1004 stores computer program code 1006 configured to cause system 1000 (where such execution represents (at least in part) the EDA tool) to be usable for performing a portion or all of the noted processes and/or methods. In one or more embodiments, storage medium 1004 also stores information which facilitates performing a portion or all of the noted processes and/or methods. In one or more embodiments, storage medium 1004 stores library 1007 of standard cells including such standard cells as disclosed herein.

EDA system 1000 includes I/O interface 1010. I/O interface 1010 is coupled to external circuitry. In one or more embodiments, I/O interface 1010 includes a keyboard, keypad, mouse, trackball, trackpad, touchscreen, and/or cursor direction keys for communicating information and commands to processor 1002.

EDA system 1000 also includes network interface 1012 coupled to processor 1002. Network interface 1012 allows system 1000 to communicate with network 1014, to which one or more other computer systems are connected. Network interface 1012 includes wireless network interfaces such as BLUETOOTH, WIFI, WIMAX, GPRS, or WCDMA; or wired network interfaces such as ETHERNET, USB, or IEEE-1364. In one or more embodiments, a portion or all of noted processes and/or methods, is implemented in two or more systems 1000.

System 1000 is configured to receive information through I/O interface 1010. The information received through I/O interface 1010 includes one or more of instructions, data, design rules, libraries of standard cells, and/or other parameters for processing by processor 1002. The information is transferred to processor 1002 via bus 1008. EDA system 1000 is configured to receive information related to a UI through I/O interface 1010. The information is stored in computer-readable medium 1004 as user interface (UI) 1042.

In some embodiments, a portion or all of the noted processes and/or methods is implemented as a standalone software application for execution by a processor. In some embodiments, a portion or all of the noted processes and/or methods is implemented as a software application that is a part of an additional software application. In some embodiments, a portion or all of the noted processes and/or methods is implemented as a plug-in to a software application. In some embodiments, at least one of the noted processes and/or methods is implemented as a software application that is a portion of an EDA tool. In some embodiments, a portion or all of the noted processes and/or methods is implemented as a software application that is used by EDA system 1000. In some embodiments, a layout diagram which includes standard cells is generated using a tool such as VIRTUOSO® available from CADENCE DESIGN SYSTEMS, Inc., or another suitable layout generating tool.

In some embodiments, the processes are realized as functions of a program stored in a non-transitory computer readable recording medium. Examples of a non-transitory computer readable recording medium include, but are not limited to, external/removable and/or internal/built-in storage or memory unit, e.g., one or more of an optical disk, such as a DVD, a magnetic disk, such as a hard disk, a semiconductor memory, such as a ROM, a RAM, a memory card, and the like.

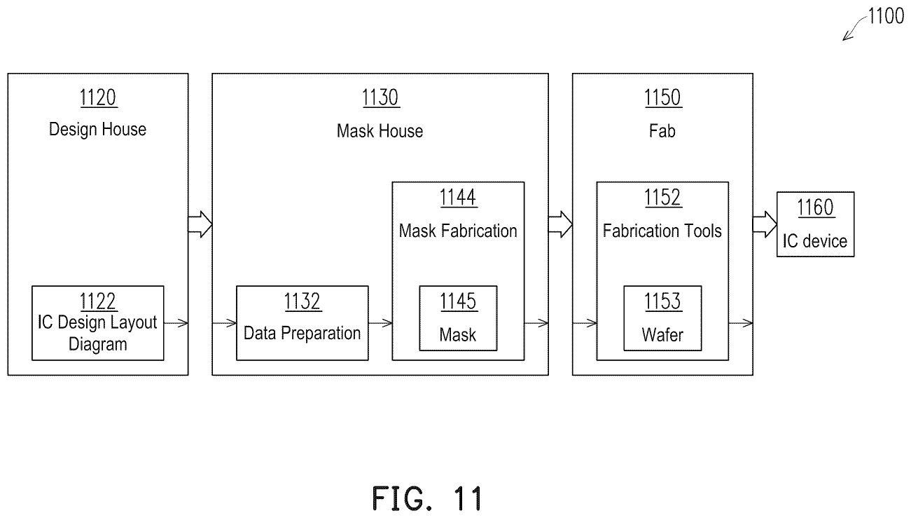

FIG. 11 is a block diagram of an integrated circuit (IC) manufacturing system 1100, and an IC manufacturing flow associated therewith, in accordance with some embodiments. In some embodiments, based on a layout diagram, at least one of (A) one or more semiconductor masks or (B) at least one component in a layer of a semiconductor integrated circuit is fabricated using manufacturing system 1100.

In FIG. 11, IC manufacturing system 1100 includes entities, such as a design house 1120, a mask house 1130, and an IC manufacturer/fabricator (“fab”) 1150, that interact with one another in the design, development, and manufacturing cycles and/or services related to manufacturing an IC device 1160. The entities in system 1100 are connected by a communications network. In some embodiments, the communications network is a single network. In some embodiments, the communications network is a variety of different networks, such as an intranet and the Internet. The communications network includes wired and/or wireless communication channels. Each entity interacts with one or more of the other entities and provides services to and/or receives services from one or more of the other entities. In some embodiments, two or more of design house 1120, mask house 1130, and IC fab 1150 is owned by a single larger company. In some embodiments, two or more of design house 1120, mask house 1130, and IC fab 1150 coexist in a common facility and use common resources.

Design house (or design team) 1120 generates an IC design layout diagram 1122. IC design layout diagram 1122 includes various geometrical patterns designed for an IC device 1160. The geometrical patterns correspond to patterns of metal, oxide, or semiconductor layers that make up the various components of IC device 1160 to be fabricated. The various layers combine to form various IC features. For example, a portion of IC design layout diagram 1122 includes various IC features, such as an active region, gate electrode, source and drain, metal lines or vias of an interlayer interconnection, and openings for bonding pads, to be formed in a semiconductor substrate (such as a silicon wafer) and various material layers disposed on the semiconductor substrate. Design house 1120 implements a proper design procedure to form IC design layout diagram 1122. The design procedure includes one or more of logic design, physical design or place-and-route operation. IC design layout diagram 1122 is presented in one or more data files having information of the geometrical patterns. For example, IC design layout diagram 1122 can be expressed in a GDSII file format or DFII file format.

Mask house 1130 includes data preparation 1132 and mask fabrication 1144. Mask house 1130 uses IC design layout diagram 1122 to manufacture one or more masks 1145 to be used for fabricating the various layers of IC device 1160 according to IC design layout diagram 1122. Mask house 1130 performs mask data preparation 1132, where IC design layout diagram 1122 is translated into a representative data file (“RDF”). Mask data preparation 1132 provides the RDF to mask fabrication 1144. Mask fabrication 1144 includes a mask writer. A mask writer converts the RDF to an image on a substrate, such as a mask (reticle) 1145 or a semiconductor wafer 1153. The design layout diagram 1122 is manipulated by mask data preparation 1132 to comply with particular characteristics of the mask writer and/or requirements of IC fab 1150. In FIG. 11, mask data preparation 1132 and mask fabrication 1144 are illustrated as separate elements. In some embodiments, mask data preparation 1132 and mask fabrication 1144 can be collectively referred to as mask data preparation.

In some embodiments, mask data preparation 1132 includes optical proximity correction (OPC) which uses lithography enhancement techniques to compensate for image errors, such as those that can arise from diffraction, interference, other process effects and the like. OPC adjusts IC design layout diagram 1122. In some embodiments, mask data preparation 1132 includes further resolution enhancement techniques (RET), such as off-axis illumination, sub-resolution assist features, phase-shifting masks, other suitable techniques, and the like or combinations thereof. In some embodiments, inverse lithography technology (ILT) is also used, which treats OPC as an inverse imaging problem.

In some embodiments, mask data preparation 1132 includes a mask rule checker (MRC) that checks the IC design layout diagram 1122 that has undergone processes in OPC with a set of mask creation rules which contain certain geometric and/or connectivity restrictions to ensure sufficient margins, to account for variability in semiconductor manufacturing processes, and the like. In some embodiments, the MRC modifies the IC design layout diagram 1122 to compensate for limitations during mask fabrication 1144, which may undo part of the modifications performed by OPC in order to meet mask creation rules.

In some embodiments, mask data preparation 1132 includes lithography process checking (LPC) that simulates processing that will be implemented by IC fab 1150 to fabricate IC device 1160. LPC simulates this processing based on IC design layout diagram 1122 to create a simulated manufactured device, such as IC device 1160. The processing parameters in LPC simulation can include parameters associated with various processes of the IC manufacturing cycle, parameters associated with tools used for manufacturing the IC, and/or other aspects of the manufacturing process. LPC takes into account various factors, such as aerial image contrast, depth of focus (“DOF”), mask error enhancement factor (“MEEF”), other suitable factors, and the like or combinations thereof. In some embodiments, after a simulated manufactured device has been created by LPC, if the simulated device is not close enough in shape to satisfy design rules, OPC and/or MRC are be repeated to further refine IC design layout diagram 1122.

It should be understood that the above description of mask data preparation 1132 has been simplified for the purposes of clarity. In some embodiments, data preparation 1132 includes additional features such as a logic operation (LOP) to modify the IC design layout diagram 1122 according to manufacturing rules. Additionally, the processes applied to IC design layout diagram 1122 during data preparation 1132 may be executed in a variety of different orders.

After mask data preparation 1132 and during mask fabrication 1144, a mask 1145 or a group of masks 1145 are fabricated based on the modified IC design layout diagram 1122. In some embodiments, mask fabrication 1144 includes performing one or more lithographic exposures based on IC design layout diagram 1122. In some embodiments, an electron-beam (e-beam) or a mechanism of multiple e-beams is used to form a pattern on a mask (photomask or reticle) 1145 based on the modified IC design layout diagram 1122. Mask 1145 can be formed in various technologies. In some embodiments, mask 1145 is formed using binary technology. In some embodiments, a mask pattern includes opaque regions and transparent regions. A radiation beam, such as an ultraviolet (UV) beam, used to expose the image sensitive material layer (e.g., photoresist) which has been coated on a wafer, is blocked by the opaque region and transmits through the transparent regions. In one example, a binary mask version of mask 1145 includes a transparent substrate (e.g., fused quartz) and an opaque material (e.g., chromium) coated in the opaque regions of the binary mask. In another example, mask 1145 is formed using a phase shift technology. In a phase shift mask (PSM) version of mask 1145, various features in the pattern formed on the phase shift mask are configured to have proper phase difference to enhance the resolution and imaging quality. In various examples, the phase shift mask can be attenuated PSM or alternating PSM. The mask(s) generated by mask fabrication 1144 is used in a variety of processes. For example, such a mask(s) is used in an ion implantation process to form various doped regions in semiconductor wafer 1153, in an etching process to form various etching regions in semiconductor wafer 1153, and/or in other suitable processes.

IC fab 1150 is an IC fabrication business that includes one or more manufacturing facilities for the fabrication of a variety of different IC products. In some embodiments, IC Fab 1150 is a semiconductor foundry. For example, there may be a manufacturing facility for the front end fabrication of a plurality of IC products (front-end-of-line (FEOL) fabrication), while a second manufacturing facility may provide the back end fabrication for the interconnection and packaging of the IC products (back-end-of-line (BEOL) fabrication), and a third manufacturing facility may provide other services for the foundry business.

IC fab 1150 includes fabrication tools 1152 configured to execute various manufacturing operations on semiconductor wafer 1153 such that IC device 1160 is fabricated in accordance with the mask(s), e.g., mask 1145. In various embodiments, fabrication tools 1152 include one or more of a wafer stepper, an ion implanter, a photoresist coater, a process chamber, e.g., a CVD chamber or LPCVD furnace, a CMP system, a plasma etch system, a wafer cleaning system, or other manufacturing equipment capable of performing one or more suitable manufacturing processes as discussed herein.

IC fab 1150 uses mask(s) 1145 fabricated by mask house 1130 to fabricate IC device 1160. Thus, IC fab 1150 at least indirectly uses IC design layout diagram 1122 to fabricate IC device 1160. In some embodiments, semiconductor wafer 1153 is fabricated by IC fab 1150 using mask(s) 1145 to form IC device 1160. In some embodiments, the IC fabrication includes performing one or more lithographic exposures based at least indirectly on IC design layout diagram 1122. Semiconductor wafer 1153 includes a silicon substrate or other proper substrate having material layers formed thereon. Semiconductor wafer 1153 further includes one or more of various doped regions, dielectric features, multilevel interconnects, and the like (formed at subsequent manufacturing steps).

In some embodiments, a system comprises a processor, and at least one memory storing instructions executable by the processor to configure the processor to perform a thermal analysis for an integrated circuit (IC) layout. The IC layout comprises a redistribution structure which comprises a plurality of conductive layers stacked one upon another in a thickness direction. In the thermal analysis, the processor is configured to, based on a thickness of each conductive layer of the plurality of conductive layers along the thickness direction and a width of conductive patterns in said each conductive layer, dividing the plurality of conductive layers into a plurality of different groups each comprising one or more conductive layers of the plurality of conductive layers. The processor is further configured to apply a plurality of different partitioning rules correspondingly to the plurality of different groups, to partition the plurality of conductive layers into a plurality of meshes. The processor is further configured to perform a thermal simulation for the IC layout based on the plurality of meshes, and, based on a result of the thermal simulation, modify the IC layout or proceed with manufacturing one or more IC devices corresponding to the IC layout.

In some embodiments, a method is performed at least partially by a processor and comprises: based on at least one physical property of a plurality of conductive layers of a redistribution structure in an integrated circuit (IC) layout, partitioning at least some of the plurality of conductive layers into a plurality of meshes having different mesh unit sizes. The method further comprises: based on the plurality of meshes, performing a thermal simulation for the IC layout. The method further comprises: based on a result of the thermal simulation, modifying the IC layout or proceeding with manufacturing one or more IC devices corresponding to the IC layout. The partitioning comprises partitioning a first conductive layer among the plurality of conductive layers into a first mesh among the plurality of meshes. The first conductive layer has a first side facing toward circuit devices in the IC layout, and a second side facing away from the circuit devices. The first mesh comprises first mesh units of a first mesh unit size on the first side of the first conductive layer, and second mesh units of a second mesh unit size on the second side of the first conductive layer. The second mesh unit size is larger than the first mesh unit size.

In some embodiments, a computer program product comprises a non-transitory, computer-readable storage medium containing therein instructions. The instructions, when executed by a processor, cause the processor to assign different boundary conditions to a plurality of off-chip interconnects of a redistribution structure in an integrated circuit (IC) layout. The instructions, when executed, further cause the processor to partition a plurality of conductive layers of the redistribution structure into a plurality of meshes having at least one predetermined mesh unit size. The instructions, when executed, further cause the processor to, based on the plurality of meshes, perform a thermal simulation for the IC layout, using the different boundary conditions assigned to the plurality of off-chip interconnects. The instructions, when executed, further cause the processor to, based on a result of the thermal simulation, modify the IC layout or proceed with manufacturing one or more IC devices corresponding to the IC layout.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A system, comprising a processor, and at least one memory storing instructions executable by the processor to configure the processor to:
perform a thermal analysis for an integrated circuit (IC) layout, the IC layout comprising a redistribution structure which comprises a plurality of conductive layers stacked one upon another in a thickness direction, wherein the processor is configured to, in the thermal analysis:
based on a thickness of each conductive layer of the plurality of conductive layers along the thickness direction and a width of conductive patterns in said each conductive layer, divide the plurality of conductive layers into a plurality of different groups each comprising one or more conductive layers of the plurality of conductive layers,
apply a plurality of different partitioning rules correspondingly to the plurality of different groups, to partition the plurality of conductive layers into a plurality of meshes, and
perform a thermal simulation for the IC layout based on the plurality of meshes; and
based on a result of the thermal simulation, modify the IC layout or proceed with manufacturing one or more IC devices corresponding to the IC layout.

2. The system of claim 1, wherein the plurality of groups comprises:
a first group, wherein the one or more conductive layers in the first group have
a thickness greater than a predetermined thickness threshold, and
a width greater than a predetermined first width threshold,
a second group, wherein the one or more conductive layers in the second group have
a thickness greater than the predetermined thickness threshold, and
a width not greater than the predetermined first width threshold,
a third group, wherein the one or more conductive layers in the third group have
a thickness not greater than the predetermined thickness threshold, and
a width greater than a predetermined second width threshold, and
a fourth group, wherein the one or more conductive layers in the fourth group have
a thickness not greater than the predetermined thickness threshold, and
a width not greater than the predetermined second width threshold.

3. The system of claim 2, wherein
the predetermined second width threshold is smaller than the predetermined first width threshold.

4. The system of claim 2, wherein
the plurality of different partitioning rules comprises:
a first partitioning rule corresponding to the first group,
a second partitioning rule corresponding to the second group, and
a third partitioning rule corresponding to the third group, and
the first and second partitioning rules differ from each other in that the width of the one or more conductive layers in the first group is partitioned into a greater number of rows of mesh units than the width of the one or more conductive layers in the second group.

5. The system of claim 2, wherein
the plurality of different partitioning rules comprises:
a first partitioning rule corresponding to the first group,
a second partitioning rule corresponding to the second group, and
a third partitioning rule corresponding to the third group, and
the first and second partitioning rules differ from the third partitioning rule in that
the thickness of the one or more conductive layers in the first group and the second group is partitioned into multiple layers of mesh units, and
the thickness of the one or more conductive layers in the third group is not partitioned and includes a single layer of mesh units.

6. The system of claim 2, wherein, along the thickness direction of the redistribution structure,
the one or more conductive layers in the third group are higher than the one or more conductive layers in the fourth group,
the one or more conductive layers in the second group are higher than the one or more conductive layers in the third group, and
the one or more conductive layers in the first group are higher than the one or more conductive layers in the second group.

7. The system of claim 2, wherein
the processor is configured to, in the thermal analysis:
calculate thermal conductivity of the one or more conductive layers in the fourth group based on a metal density of the one or more conductive layers in the fourth group, and
perform the thermal simulation for the IC layout further based on the calculated thermal conductivity of the one or more conductive layers in the fourth group.

8. A method, the method performed at least partially by a processor and comprising:
based on at least one physical property of a plurality of conductive layers of a redistribution structure in an integrated circuit (IC) layout, partitioning at least some of the plurality of conductive layers into a plurality of meshes having different mesh unit sizes;
based on the plurality of meshes, performing a thermal simulation for the IC layout; and
based on a result of the thermal simulation, modifying the IC layout or proceeding with manufacturing one or more IC devices corresponding to the IC layout,
wherein
said partitioning comprises partitioning a first conductive layer among the plurality of conductive layers into a first mesh among the plurality of meshes,
the first conductive layer has a first side facing toward circuit devices in the IC layout, and a second side facing away from the circuit devices, and
the first mesh comprises:
first mesh units of a first mesh unit size on the first side of the first conductive layer, and
second mesh units of a second mesh unit size on the second side of the first conductive layer, the second mesh unit size larger than the first mesh unit size.

9. The method of claim 8, wherein
the at least one physical property comprises at least one of a thickness, a pitch, a width or a length of conductive patterns in each of the plurality of conductive layers.

10. The method of claim 8, wherein
the plurality of conductive layers further comprises a second conductive layer,
the at least one physical property of the first conductive layer is greater than that of the second conductive layer, and
said partitioning comprises:
partitioning the second conductive layer into a second mesh among the plurality of meshes, the second mesh having a mesh unit size smaller than the first mesh unit size in at least one of a width direction or a length direction, the width direction and the length direction transverse to each other and to a thickness direction of the redistribution structure.

11. The method of claim 8, wherein
the plurality of conductive layers further comprises a second conductive layer,
a thickness of the first conductive layer along a thickness direction of the redistribution structure is greater than that of the second conductive layer, and
said partitioning comprises:
partitioning the first conductive layer into the first mesh having multiple layers of the first and second mesh units along the thickness direction, and
partitioning the second conductive layer into a second mesh among the plurality of meshes, the second mesh having a single layer of mesh units along the thickness direction.

12. The method of claim 11, wherein
the plurality of conductive layers further comprises a third conductive layer,
a thickness of the third conductive layer along the thickness direction is greater than that of the second conductive layer,
said partitioning comprises partitioning the third conductive layer into a third mesh among the plurality of meshes, the third mesh having multiple layers of mesh units along the thickness direction,
a width of conductive patterns of the first conductive layer is greater than that of the third conductive layer,
in the first mesh, multiple rows of the first and second mesh units represent the width of each conductive pattern of the first conductive layer, and
in the third mesh, a single row of mesh units represents the width of each conductive pattern of the third conductive layer.

13. The method of claim 8, wherein
said partitioning comprises partitioning each of the plurality of conductive layers into a corresponding mesh among the plurality of meshes, the corresponding mesh having a mesh unit size different from mesh unit sizes of all other meshes among the plurality of meshes.

14. The method of claim 8, wherein
the first mesh comprises:
a first layer of the first mesh units of the first mesh unit size on the first side of the first conductive layer, and
a second layer of the second mesh units of the second mesh unit size on the second side of the first conductive layer.

15. The method of claim 14, wherein
the first mesh unit size has a same width as the second mesh unit size,
the first mesh unit size has a same length as the second mesh unit size, and
the first mesh unit size has a first thickness smaller than a second thickness of the second mesh unit size.

16. The method of claim 15, wherein
the first mesh further comprises, between the first layer and the second layer, a third layer of third mesh units of a third mesh unit size,
the third mesh unit size has the same width and the same length as the first mesh unit size and second mesh unit size, and
the third mesh unit size has a third thickness smaller than the second thickness of the second mesh unit size, and larger than the first thickness of the first mesh unit size.

17. The method of claim 8, wherein
the plurality of conductive layers comprises a lowermost conductive layer closest to the circuit devices in the IC layout, and
the method further comprises:
based on a metal density of the lowermost conductive layer, calculating thermal conductivity of the lowermost conductive layer, and
using the calculated thermal conductivity of the lowermost conductive layer in the thermal simulation for the IC layout.

18. A computer program product, comprising a non-transitory, computer-readable storage medium containing therein instructions which, when executed by a processor, cause the processor to:
assign different boundary conditions to a plurality of off-chip interconnects of a redistribution structure in an integrated circuit (IC) layout,
partition a plurality of conductive layers of the redistribution structure into a plurality of meshes having at least one predetermined mesh unit size,
based on the plurality of meshes, perform a thermal simulation for the IC layout, using the different boundary conditions assigned to the plurality of off-chip interconnects, and
based on a result of the thermal simulation, modify the IC layout or proceed with manufacturing one or more IC devices corresponding to the IC layout.

19. The computer program product of claim 18, wherein
the at least one predetermined mesh unit size comprises a plurality of predetermined different mesh unit sizes corresponding to the plurality of conductive layers, and
the instructions, when executed by the processor, cause the processor to
access a table storing the plurality of predetermined different mesh unit sizes in correspondence with the plurality of conductive layers, and
partition each of the plurality of conductive layers using the corresponding mesh unit size stored in the table.

20. The computer program product of claim 18, wherein
the at least one predetermined mesh unit size is a common mesh unit size for all of the plurality of conductive layers, and
the instructions, when executed by the processor, further cause the processor to:
partition the plurality of conductive layers of the redistribution structure into the plurality of meshes having the same common mesh unit size.
